(19) United States
(12) Patent Application Publication
(10) Pub. No.: US 2012/0122711 A1
(43) Pub. Date: May 17, 2012

(54) SCREENING OF BIOPOLYMERS

(76) Inventors: James R. Heath, Pasadena, CA (US); Su Seong Lee, Singapore (SG); Jaehong Lim, Singapore (SG); Junhoe Cha, Singapore (SG); Sylvia Tan, Singapore (SG); Shi Yun Yeo, Singapore (SG); Yi Li Ang, Singapore (SG); Yiran Zhang, Singapore (SG)

(21) Appl. No.: 13/384,510

(22) PCT Filed: Jul. 15, 2010
(86) PCT No.: PCT/SG10/00266

§ 371 Date: Jan. 17, 2012

Related U.S. Application Data
(60) Provisional application No. 61/225,881, filed on Jul. 15, 2009.

(51) Int. Cl. C40B 30/00; C40B 50/18; C40B 40/12; C40B 40/06; C40B 40/10

(52) U.S. Cl. 506/7; 506/16; 506/18; 506/19; 506/32

(57) ABSTRACT

Described herein are inventive compositions and methods relating to sampling of biopolymers and, in particular, to fractional sampling of biopolymers. In one aspect, embodiments are generally related to unique biopolymer species where a fraction of each biopolymer species contains a cleavable linker. The biopolymer species may, in some embodiments, be attached to a surface. For example, the biopolymer species may be attached to beads. In some embodiments, a portion of a unique biopolymer species may be sampled by cleaving the cleavable linker. In some cases, the sample may be analyzed to determine the sequence of the biopolymer.

### RELATED APPLICATIONS

This application claims the benefit of International Patent Application No. PCT/SG2009/000258, filed Jul. 22, 2009, entitled “Differentiation of Isobaric Amino Acids and Other Species,” by Heath et al., and U.S. Provisional Patent Application No. 61/225,881, filed Jul. 15, 2009, entitled “Method for the Improved Screening of Bead-Based Peptide and Peptide Mimetic Libraries Using Partially Cleavable Peptides,” by Heath et al., both of which are incorporated herein by reference.

### FIELD OF INVENTION

Described herein are inventive compositions and methods relating to sampling of biopolymers and, in particular, to fractional sampling of biopolymers.

### BACKGROUND

Split-and-mix synthesis approaches have been used to produce peptide libraries on small beads, with each bead containing an individual peptide molecule. Such libraries are referred to as one-bead-one-compound (OBOC) libraries. A common use of OBOC libraries is to identify molecules from the libraries that perform some function of interest. As an example, an OBOC library may be used to identify a molecule (i.e., a peptide) that binds to a particular protein by screening the library for beads that are associated with the protein (“hit” beads). The hit beads can be separated from the rest of the library, and the identity of the peptide on a particular hit bead can be determined using a peptide sequencing strategy.

### SUMMARY OF THE INVENTION

Described herein are inventive compositions and methods relating to sampling of biopolymers and, in particular, to fractional sampling of biopolymers.

In one aspect, a composition is provided. The composition comprises a mixture of a first biopolymer and a second biopolymer, wherein the second biopolymer is identical to the first biopolymer except at one or more locations where the second biopolymer contains a cleavable linker.

In some embodiments, the first biopolymer and the second biopolymer each comprise amino acid sequences.

In other embodiments, the first biopolymer and the second biopolymer each comprise nucleic acid sequences.

In still other embodiments, the first biopolymer and the second biopolymer each comprise polysaccharides.

In yet other embodiments, the cleavable linker is methionine.

In still other embodiments, the first biopolymer and the second biopolymer are attached to a surface.

In yet other embodiments, the surface is the external surface of a particle.

In still other embodiments, the ratio of the first biopolymer to the second biopolymer is greater than 1:1.

In yet other embodiments, the composition further comprises a plurality of said mixtures, wherein each mixture is attached to a separate particle.

In still other embodiments, the first biopolymer comprises an anchor amino acid sequence and an N-terminus amino acid sequence extension.

In yet other embodiments, the first biopolymer comprises an anchor amino acid sequence and a C-terminus amino acid sequence extension.

In still other embodiments, the second biopolymer is at least one subunit longer than the first biopolymer.

In yet other embodiments, the second biopolymer comprises at least one more amino acid than the first biopolymer.

In still other embodiments, the second biopolymer has the same number of amino acids as the first biopolymer.

In another aspect, a method is provided. The method comprises growing biopolymers on a surface, wherein during the growing step a cleavable linker precursor is added to a medium containing the biopolymers and incorporated into the biopolymers such that only a portion of the biopolymers grown on the surface contain a cleavable linker derived from the cleavable linker precursor.

In yet another aspect, a method is provided. The method comprises mixing a plurality of biopolymers with at least one surface and attaching the plurality of biopolymers to the at least one surface such that only a portion of the biopolymers attached to the surface contain a cleavable linker.

In some embodiments, the cleavable linker precursor comprises at least one amino acid.

In other embodiments, less than one equivalent of the cleavable linker precursor with respect to reactive centers on the sequences is added to the medium.

In yet other embodiments, the medium further comprises an amino acid precursor distinguishable from the cleavable linker.

In still other embodiments, the ratio of the amino acid precursor to the cleavable linker precursor is greater than 1:1.

In yet other embodiments, the ratio of the amino acid precursor to the cleavable linker precursor is greater than 5:1.

In still other embodiments, the amino acid precursor comprises a first protecting group and the cleavable linker precursor comprises a second protecting group different from the first.

In yet other embodiments, the method further comprises growing biopolymers on a plurality of individual particles, wherein each particle comprises a unique biopolymer.

In yet another aspect, a composition is provided. The composition comprises a biopolymer containing a binding region and a cleavable linker, wherein the binding region and the cleavable linker are separated by a distance sufficient to reduce the binding affinity of the binding region for a target species by less than 20%.

In still another aspect, a composition is provided. The composition comprises a biopolymer containing a binding region and a cleavable linker, wherein the binding region and the cleavable linker are separated by at least two biopolymer subunits.

In yet another aspect, a composition is provided. The composition comprises a biopolymer containing a binding region and a cleavable linker, wherein the cleavable linker is located within five biopolymer subunits of a terminus of the biopolymer.

In some embodiments, the binding region is an epitope.

In other embodiments, the binding region and cleavable linker are separated by at least two biopolymer subunits.

In still other embodiments, the biopolymer comprises an amino acid sequence, and wherein the cleavable linker is located within five amino acids of the C-terminus of the amino acid sequence.

In yet other embodiments, a first plurality of the biopolymers are attached to a surface.

In still other embodiments, a second plurality of the biopolymers are attached to the surface, wherein the second plurality of the biopolymers are identical to the first plurality of the biopolymers except at one or more locations where the biopolymers of the second plurality of biopolymers contain a cleavable linker.

In yet other embodiments, the surface is the external surface of a particle.

In still other embodiments, the composition further comprises a library of unique biopolymers, wherein each of the biopolymers is attached to a separate particle.

In still another aspect, a method of screening a library of biopolymers is provided. The method comprises providing a plurality of particles, wherein each particle comprises a unique first biopolymer and a unique second biopolymer, the second biopolymer comprising a cleavable linker, contacting the plurality of particles with a target, isolating members of the plurality of particles that bind above a threshold level with the target, cleaving cleavable linkers on the isolated members of the plurality of particles to release a fragment of the second biopolymer, and determining the sequence of the fragment of the second biopolymer.

In yet another aspect, a library is provided. The library comprises a plurality of particles, wherein each of the particles has attached thereto a first biopolymer and a second biopolymer, wherein the second biopolymer is identical to the first biopolymer except at one or more locations where the second biopolymer contains a cleavable linker.

Other advantages and novel features of the present invention will become apparent from the following detailed description of various non-limiting embodiments of the invention when considered in conjunction with the accompanying figures. Unless otherwise noted, all references cited herein are incorporated by reference in their entirety. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 shows a particle having attached thereto a first biopolymer and a second biopolymer having a cleavable linker.

FIG. 2 shows two methods for generating beads containing fractional amounts of methionine at specific positions by limiting the added reagents, according to an embodiment;

FIG. 3 shows two methods for generating beads containing fractional amounts of methionine at specific positions by using pre-mixed amino acid reagents, according to an embodiment;

FIG. 4 shows a standard calibration curve obtained by running LC with variable amounts of the peptide Ac-Phe-Leu-homoserine lactone, which was used to achieve precise fractional coupling relative to full saturation (=100%), according to an embodiment. (A) Liquid chromatography data, collected as a function of the relative amounts of the standard peptide. On each chromatogram the integrated peak area (numbers below “Area”), as well as the % peptide used (numbers below “Peptide”, which were obtained by dilution of the standard peptide solution. (B) Plot of the measured amount of cleaved peptide (relative scale) versus % peptide for LC running. The area was normalized relative to the value of full saturation (=100%) obtained by double coupling method;

FIG. 5 shows chromatograms of the peptide Ac-Phe-Leu-homoserine lactone obtained by CNBr cleavage from variable fractions of methionine in three types of beads, according to an embodiment;

FIG. 6 shows sequencing from a single bead with 10% cleavable linker, according to an embodiment. Sequencing results and representative MS spectra from 6 pentameric peptides linked via 10% methionine to a backbone (HLYFLR) (SEQ ID NO. 1) (A) at N-terminus (linear case) and (B) at a mid-point (branched case);

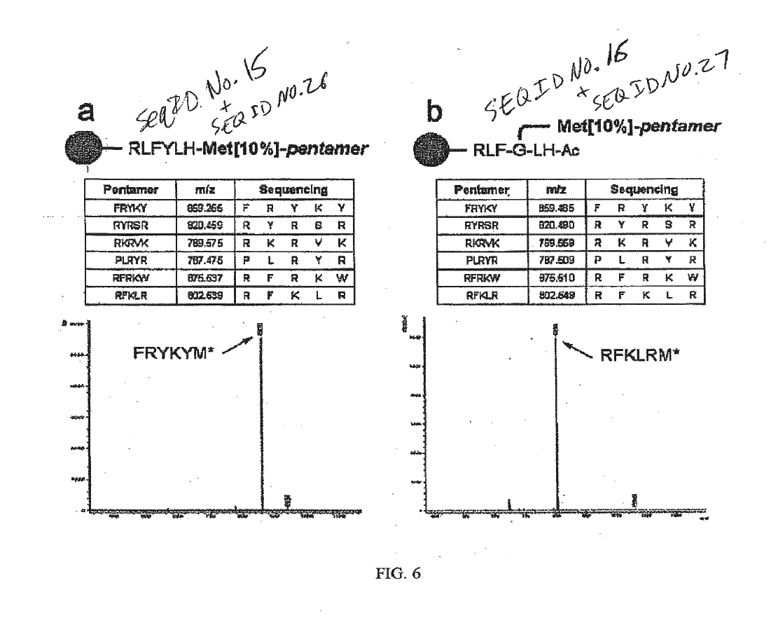

FIG. 7 shows position-dependent histograms, (A) from 45 hit beads screened with the peptide library of 15% methionine linker, (B) from 48 hit beads screened with the peptide library of 100% methionine linker, according to an embodiment. Each histogram resulted from screening 100 mg of beads;

FIG. 8 shows position-dependent histograms, (A) from 37 hit beads screened with the peptide library of 15% methionine linker, (B) from 32 hit beads screened with the peptide library of 100% methionine linker, according to an embodiment. Each histogram resulted from screening 100 mg of beads.

FIG. 9 shows (A) structures; (B) SPR sensograms; and (C) dot blot experiments of hexamer-1 and decamer-N1 towards bCAII and hCAII, according to an embodiment;

FIG. 10 shows (A) overall flow from the initial anchor hexamer-2 to the three N-terminus elongated decameric peptides; and (B) dot blot experiments of the three decameric peptides in comparison with the hexamer-2 and commercially available polyclonal antibody for CAII, according to an embodiment;

FIG. 11 shows (A) overall flow from the initial anchor hexamer-2 to the three C-terminus elongated decameric peptides; and (B) dot blot experiments of the three decameric peptides in comparison with the hexamer-2 and commercially available polyclonal antibody for CAII, according to an embodiment;

FIG. 12 shows (A) overall flow from the initial anchor hexamer-2 to the combined peptide tetradecamer-N2C via the two elongated peptides decamer-N2 and decamer-C2; and (B) dot blot experiments of the tetradecamer-N2C in comparison with the hexamer-2, decamer-N2, decamer-C2, along with the two peptides without anchor motif and commercially available polyclonal antibody for CAII, according to an embodiment;

FIG. 13 shows a flowchart of synchronous elongation at multiple points to efficiently produce multi-ligand-like captures agents that may be able to replace antibodies, according to an embodiment;

FIG. 14 shows SPR sensograms of (A) hexamer-2; (B) decamer-C2; (C) decamer-N2; and (D) tetradecamer-N2C, according to an embodiment. The Rₘₐₓ for immobilization was RU=1000. The concentrations spanned from 1 μM to 8 nM; and

FIG. 15 shows SPR sensograms of (A) RYRR-G₆-WRYP (SEQ ID NO. 2); (B) RYRR-PEG₄-WRYP (SEQ ID NO. 3); (C) RYRR (SEQ ID NO. 4); and (D) WRYP (SEQ ID NO. 5), according to an embodiment. The Rₘₐₓ for immobilization was RU=1000. The concentrations spanned from 1 μM to 8 nM.

### DETAILED DESCRIPTION

Described herein are inventive compositions and methods relating to sampling of biopolymers and, in particular, to fractional sampling of biopolymers. In one aspect, embodiments are generally related to unique biopolymer species where a fraction of each biopolymer species contains a cleavable linker. The biopolymer species may, in some embodiments, be attached to a surface. For example, the biopolymer species may be attached to beads. In some embodiments, a portion of a unique biopolymer species may be sampled by cleaving the cleavable linker. In some cases, the sample may be analyzed to determine the sequence of the biopolymer.

In one aspect, embodiments allow a portion of a biopolymer species to be cleaved. For instance, in some cases it may be desirable to incorporate a cleavable linker into some molecules of a biopolymer species while leaving other molecules of the biopolymer species essentially free of the cleavable linker. For example, a cleavable linker, in some embodiments, may affect the binding strength of a biopolymer species for a target species. It may thus be desirable to have at least some of the biopolymer species be cleavable such that a sample of the biopolymer species may be collected and have the remaining biopolymer species be essentially free of the cleavable linker so as not to affect substantially the binding of the biopolymer species and the target species.

In some embodiments, cleaving a biopolymer species may allow a sample of the biopolymer species to be collected. Cleaving a biopolymer species may be desirable, for example, when the identity of the biopolymer species, or the identity of a region within the biopolymer species, is unknown. In some embodiments, the sample of the biopolymer species may be subjected to an assay for determining the identity of the biopolymer species. For example, in some embodiments, the biopolymer species may be sequenced, as discussed in more detail below.

In some embodiments, the biopolymer species may be attached to a surface. The surface may be any suitable surface. In some cases, the surface may comprise a metal, a metalloid, a ceramic, or a polymer. For example, in some cases the surface may comprise gold, silver, silicon, or glass (e.g., controlled pore glass). In some embodiments, the surface may be polymeric. For instance, the surface may comprise non-degradable or degradable polymers. In one embodiment, the surface may comprise polystyrene.

In some embodiments, the surface may be the surface of a particle (i.e., a bead). In some cases, the bead may have a diameter of less than 100 microns, in certain embodiments less than 10 microns, or in certain embodiments less than 1 micron.

In some embodiments, the surface may be functionalized with a reactive group to which a monomer or biopolymer may be coupled. In some cases, the reactive group may be directly attached to the surface. In some embodiments, the reactive group may be indirectly attached to the surface using a linker (e.g., PEG). Non-limiting examples of reactive groups include carboxyls, alcohols, amines, and thiols.

The biopolymer species may be any suitable polymer suspected of or capable of interacting with a target species. A target species may be any biological target including, but not limited to, an organism, a cell, a membrane, a protein, an enzyme, an antibody, a receptor, a transcription factor, a growth factor a nucleic acid, an aptamer, a ribozyme, a polysaccharide, etc. A biopolymer may be naturally-occurring or synthetic. In some embodiments, the biopolymer species comprises one or more naturally-occurring subunits. Non-limiting examples of naturally-occurring subunits include nucleotides, amino acids, and sugars. In some cases, the biopolymer species may comprise synthetic subunits, such as synthetic nucleotides, synthetic amino acids, and synthetic sugars. In some embodiments, the biopolymer species may include a mixture of naturally-occurring and synthetic subunits. In some embodiments, the biopolymer may incorporate subunits that serve as linkers, chain extenders, reactive centers, solubility enhancers, degradation centers, or the like.

Polymers are generally extended molecular structures comprising backbones which optionally contain pendant side groups (e.g., nucleobases and/or amino acid side groups). As used herein, “backbone” is given its ordinary meaning as used in the art, e.g., a linear chain of atoms within the polymer molecule by which other chains of atoms may be regarded as being pendant. Typically, but not always, the backbone is the longest chain of atoms within the polymer. In some embodiments, a polymer may be branched at one or more branch points. In such instances, a branch may not be regarded as a pendant side group but rather a separate polymer chain which itself is connected to a polymer chain at a branch point. For example, an amino acid sequence may have “Y” configuration, where a single amino acid sequence diverges to two amino acid sequence at a branch point. A polymer may be a co-polymer, for example, a block, alternating, or random co-polymer.

An exemplary, non-limiting list of polymer species include polysaccharides; polynucleotides (e.g., DNA and/or RNA); polypeptides (i.e., amino acid sequences); peptide nucleic acids; polyurethane; polyamides; polycarbonates; polyanhydrides; polydioxanone; polyacetylenes and polydiacetylenes; polyphosphazenes; polysiloxanes; polyolefins; polyamines; polyesters; polyethers; poly(ether ketones); poly(alkaline oxides); poly(ethylene terephthalate); poly(methyl methacrylate); polystyrene; poly(lactic acid)/polylactide; poly(glycolic acid); poly(lactic-co-glycolic acid); poly(caprolactone); poly(orthoesters); poly(ether esters) such as polydioxanone; poly(amino carbonates); and poly(hydroxyalkanoates) such as poly(3-hydroxybutyrate) and poly(3-hydroxybutyrate-co-3-hydroxyvalerate) and derivatives and block, random, radial, linear, or teleblock copolymers of the above.

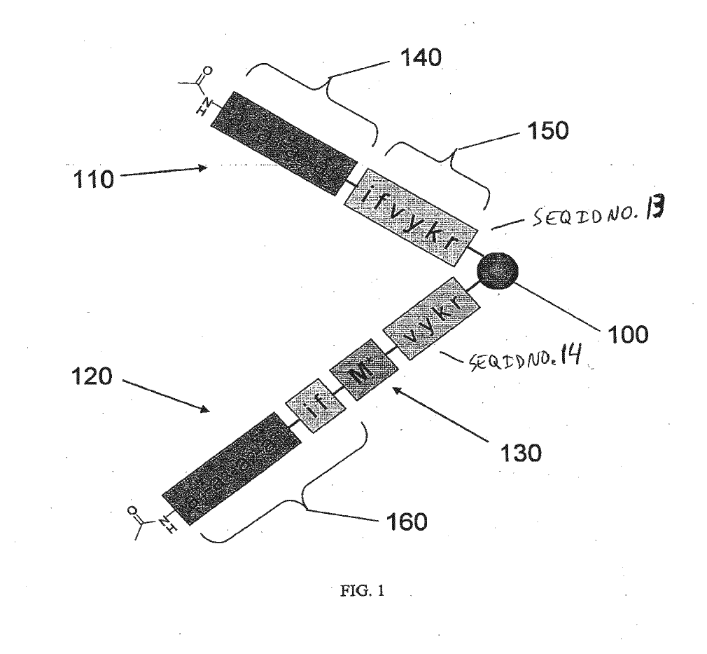

A non-limiting example will now be described. FIG. 1 shows a particle 100 having a first biopolymer species 110 and a second biopolymer species 120 attached to the surface of the particle. It should be understood that although particles are described in FIG. 1, this is by way of example only, and in other embodiments, other systems may be used, e.g., the first biopolymer species and the second biopolymer species may be in solution, attached to a planar substrate, or the like. The particle may be part of a library of unique particles, where the first biopolymer species and the second biopolymer species are unique on each unique particle. It should be understood that a library may contain multiple copies of one or more of the unique particles. The first biopolymer species 110 comprises a sequence of amino acid subunits chosen from a pool of subunits. The second biopolymer species 120 comprises an identical sequence of amino acid subunits as the first biopolymer species 110, except that a cleavable linker 130 is inserted between two of the subunits of the second biopolymer species. In the non-limiting embodiment shown in FIG. 1, the cleavable linker 130 is a methionine subunit. The first biopolymer species includes a variable sequence 140 and an anchor sequence 150. The variable sequence 140 is unique on each unique particle, whereas the anchor sequence 150 is identical on each unique particle. A portion 160 of the second biopolymer species may be cleaved from the particle, e.g., via cleavable linker 130, as described in more detail below, to form a mixture that can be subsequently analyzed by mass spectrometry (or other techniques) to determine the sequence of variable sequence 140.

In some embodiments, the first biopolymer species and the second biopolymer species may have the same number of subunits. In some cases, the second biopolymer species may have more subunits than the first biopolymer species. In some instances, the second biopolymer species may have fewer subunits that the first biopolymer species. For example, in some embodiments, the second biopolymer species may have at least one more subunit, in certain embodiments at least two more subunits, in certain embodiments at least three more subunits, and in certain embodiments at least four more subunits. In some cases, the first biopolymer species and the second polymer species may be identical except at one or more locations where the second biopolymer species is modified. For example, as discussed above, the second biopolymer species may contain a cleavable linker, whereas the first biopolymer species may not contain a cleavable linker. In some cases, the first biopolymer species and a second biopolymer species may have identical sequences except that the cleavable linker may be inserted between two subunits of the second biopolymer species, thereby increasing the length of the second biopolymer species by one subunit relative to the first biopolymer species. In some cases, the first biopolymer species and the second biopolymer species may have identical sequences and identical lengths except at one or more locations where a subunit of the second biopolymer species is replaced with a cleavable linker.

A biopolymer may have any suitable length. In some embodiments, the biopolymer may have at least five subunits, in certain embodiments at least ten subunits, in certain embodiments at least fifteen subunits, in certain embodiments at least twenty subunits, in certain embodiments at least twenty-five subunits, in certain embodiments at least thirty subunits, in certain embodiments at least thirty-five subunits, and in certain embodiments at least forty subunits.

The ratio of the first biopolymer species to the second biopolymer species may be any desired ratio. In some embodiments, it may be desirable to have a ratio of greater than 1:1, in certain embodiments greater than 2:1, in certain embodiments greater than 5:1, and in certain embodiments greater than 9:1 in certain embodiments greater than 20:1, and in certain embodiments greater than 50:1. In some embodiments, the ratio may be chosen such that a quantity of the second biopolymer species sufficient for analysis may be sampled by cleaving the second biopolymer species.

In certain embodiments, a mixture of biopolymer species may not be used, and instead only a single biopolymer species may be used. In some embodiments, all of the single biopolymer species may be cleavable.

As discussed above, in some embodiments, the presence of a cleavable linker in the second biopolymer species may affect the binding affinity of the second biopolymer species for a target species. In some embodiments, the presence of the cleavable linker may alter the effective binding affinity of the combination of the first biopolymer species and the second biopolymer species for a target species as compared to the binding affinity of the first biopolymer species for the target species. Of course, the effective binding affinity of the combination may be dependent on factors such as the ratio of the first biopolymer species to the second biopolymer species and the magnitude of the effect of the cleavable linker on the binding affinity of the second biopolymer species for a target species. In some cases, the magnitude of the effect may be dependent on the structure of the cleavable linker, the identity of biopolymer subunits within proximity (i.e., adjacent, within two subunits, within three subunits, within four subunits, within five subunits, etc.) to the cleavable linker, and the proximity of the cleavable linker to binding regions within the biopolymer (e.g., epitopes). Thus, the desired ratio of the first biopolymer species to the second biopolymer species may differ depending on these and other properties.

Any suitable cleavable linker may be used. Such linkers are known to those skilled in the art, for example in solid-phase peptide synthesis and solid-phase oligonucleotide synthesis. In some instances, a methionine residue may be used as a linker. A methionine linker may be cleaved by a reagent such as CNBr, which cleaves peptide bonds at the C-terminus of methionine residues. Examples of other types of linkers that may be used include acid-cleavable linkers, base-cleavable linkers, photo-cleavable linkers, and redox-cleavable linkers such as those mediated by periodate, 2,3-Dichloro-5,6-Dicyanobenzoquinone (DDQ), cerium (IV) ammonium nitrate (CAN), etc. The cleavable linker may be susceptible to cleavage under conditions that are essentially benign to the biopolymer. In some embodiments, the cleavable linker may be located within the biopolymer sequence. In some embodiments, a cleavable linker may be used to connect a biopolymer to a surface (i.e., a particle). For example, the cleavable linker may be located at the C-terminus of a peptide.

In some embodiments, the cleavable linker may be separated from a binding region (e.g., an epitope) of the biopolymer by a distance sufficient to reduce the binding affinity of the binding epitope for a target by less than a certain amount. For example, in some embodiments, the reduction in binding affinity may be less than 20%, in certain embodiments less than 15%, in certain embodiments less than 10%, and in certain embodiments less than 5%. In some embodiments, a binding region may be defined by a particular sequence of subunits within a biopolymer. In some cases, the binding region and the cleavable linker may be separated by at least one biopolymer subunit, in certain embodiments by at least two biopolymer subunits, in certain embodiments by at least three biopolymer subunits, in certain embodiments by at least four biopolymer subunits, in certain embodiments by at least five biopolymer subunits, in certain embodiments by at least six biopolymer subunits, in certain embodiments by at least seven biopolymer subunits, in certain embodiments by at least eight biopolymer subunits, in certain embodiments by at least nine biopolymer subunits, and in certain embodiments by at least ten biopolymer subunits.

In some embodiments, the cleavable linker may be located within proximity to a terminus of the biopolymer. For example, in some embodiments, the cleavable linker may be located at the terminus of the biopolymer, in certain embodiments one biopolymer subunit away from the terminus, in certain embodiments within two biopolymer subunits of the terminus, in certain embodiments within three biopolymer subunits of the terminus, in certain embodiments within four biopolymer subunits of the terminus, in certain embodiments within five biopolymer subunits of the terminus, in certain embodiments within ten biopolymer subunits of the terminus, and in certain embodiments within twenty biopolymer subunits of the terminus.

In some embodiments, the position of the cleavable linker within a biopolymer may be chosen such that the biopolymer fragments produced upon cleavage have particular lengths. For example, in some embodiments, it may be desirable to produce a fragment having a length that facilitates analysis. For instance, sequencing of biopolymer fragments may be facilitated by analyzing fragments having a length of 6, 7, or 8 biopolymer subunits. Of course, biopolymer fragments having lengths outside this range may be analyzed as well. In some embodiments, the biopolymer fragment may have a length of at least four biopolymer subunits, in certain embodiments at least six biopolymer subunits, in certain embodiments at least eight biopolymer subunits, or in certain embodiments at least ten biopolymer subunits.

In some embodiments, a library of biopolymer species may be provided. As discussed above, in some cases, the biopolymer species may be attached to a surface (e.g., the surface of a particle). In some embodiments, the library may comprise a plurality of unique biopolymer species, where each unique biopolymer species may be attached to a unique region of a surface. For example, the plurality of unique biopolymer species may be arranged in an array on a surface. In some cases, each unique biopolymer species may be attached to the surface of a separate particle. In some embodiments, at least some of the biopolymer species in each region or on each particle may comprise a cleavable linker.

In some embodiments, a library may comprise at least 100 unique biopolymers, in certain embodiments at least 500 unique biopolymers, in certain embodiments at least 1000 unique biopolymers, in certain embodiments at least 5000 unique biopolymers, and in certain embodiments at least 10000 unique biopolymers.

In some cases, each member of the library of biopolymers may comprise a fixed sequence region (e.g., an anchor sequence) and a variable sequence region. In some embodiments, the anchor sequence may comprise a sequence having at least some binding affinity for a target species. As discussed in more detail below, in some embodiments, extension of the anchor sequence, for example with a variable sequence region, may increase the binding affinity of the biopolymer species depending on the sequence of the extension. In some cases, a library of unique biopolymer species may be screened to identify particular sequences having improved binding affinity for a particular target species. An anchor sequence may be any suitable length. For example, the anchor region may at least 1, 2, 5, 10, 15, 20, 25, 30, 35, or 40 subunits in length. In some embodiments, the variable sequence region may be at least 1, 2, 4, or 8 subunits in length. The anchor sequence and the variable sequence region may be directly connected or may be connected by a suitable linker. For example, the linker may be of a different species than the majority of monomers in the biopolymer (e.g., the linker may comprise PEG or 4-aminobutyrate, whereas the rest of the biopolymer may be a peptide). In some embodiments, the linker may be an amino acid sequence (e.g., polyglycine). The anchor sequence may be extended by either or both termini. For example, an amino acid anchor sequence may be extended at the N-terminus and/or the C-terminus. The extension may be variable or fixed.

A biopolymer may be constructed using any standard method, such as standard automated solid phase synthesis methods. In some cases, a biopolymer may constructed enzymatically. In some embodiments, a biopolymer may be constructed in step-wise fashion, i.e., by addition of one or more subunits to a growing biopolymer chain. In some embodiments, separately constructed biopolymer fragments may be joined to form a full-length biopolymer. In certain embodiments, a biopolymer may be directly grown on a surface (e.g., the surface of a particle). In some embodiments, a biopolymer may be constructed and subsequently attached to a surface. In some cases, a plurality of biopolymers may be mixed with at least one surface such that the biopolymers react with one or more functional groups on the at least one surface to become attached. Many methods may be used to attach a biopolymer to a surfaces. For example, in some cases, a biopolymer may comprise a thiol group that may react with a metal surface, such as gold, to attach the biopolymer to the surface. In another example, the biopolymer may comprise a carboxyl group that may react with an amine on a surface to attach the biopolymer to the surface. Numerous linkers and reagents are known in the art for performing these reactions.

In some embodiments, biopolymer monomers may comprise one or more groups that are transformed or removed during or after synthesis of the biopolymer. That is, a biopolymer monomer may be a “precursor.” For example, amino acid monomers may comprise an fmoc protecting group on the amino terminus that is removed prior to addition of a subsequent monomer, i.e., the amino acid monomer may be an “amino acid precursor.” In another example, a nucleoside phosphoramidite comprises a phosphoramidite at the 3′ position that is transformed to a phosphate during oligonucleotide synthesis.

Likewise, a precursor of a cleavable linker may be used to incorporate the cleavable linker into the biopolymer. In some embodiments, the cleavable linker precursor may be a single monomer. In some cases, the cleavable linker may comprise one or more additional monomers attached to the cleavable linker. For example, a cleavable linker precursor may include a methionine cleavable linker attached to one or more amino acids. Incorporation of such a cleavable linker precursor results in addition to the biopolymer of the cleavable linker plus the one or more amino acids attached to the cleavable linker.

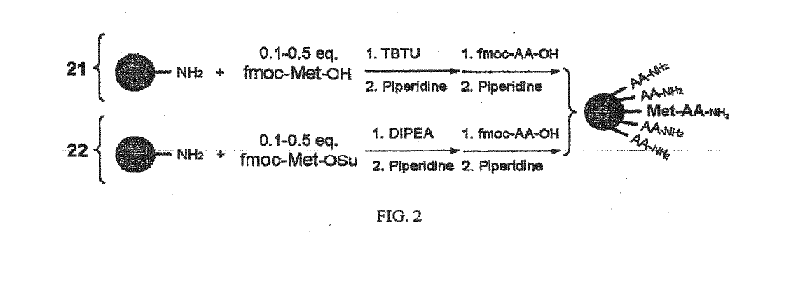

A cleavable linker may be incorporated into a fraction of growing biopolymer chains by any suitable method. In some embodiments, a limiting reagent approach may be used, as shown in FIG. 2. For example, provided with a plurality of biopolymer chains, a cleavable linker precursor may be added in an amount such that the cleavable linker precursor is added to only a fraction of the plurality of the biopolymer chains. In some embodiments, the amount of cleavable linker precursor needed to achieve this results may vary depending on the reactivity of the cleavable linker precursor. For instance, in some cases, the desired fraction of biopolymers containing a cleavable linker may be achieved by contacting the growing biopolymer chains with an essentially equivalent amount of cleavable linker precursor, i.e., contacting the growing biopolymer chains with about 0.1 equivalents of cleavable linker precursor to result in 10% of the biopolymer chains having a cleavable linker, etc. However, in other instances, it may be necessary to use a larger amount of cleavable linker precursor to achieve essentially the same result. In some embodiments, less than 10 equivalents of the cleavable linker precursor are mixed with the biopolymer chains, in certain embodiments less than 5 equivalents of the cleavable linker precursor are mixed with the biopolymer chains, in certain embodiments less than 1 equivalent of the cleavable linker precursor is mixed with the biopolymer chains, in certain embodiments less than 0.5 equivalents of the cleavable linker precursor are mixed with the biopolymer chains, and in certain embodiments less than 0.1 equivalents of the cleavable linker precursor are mixed with the biopolymer chains. Following addition of the cleavable linker precursor, additional monomers may be added to the biopolymer chains.

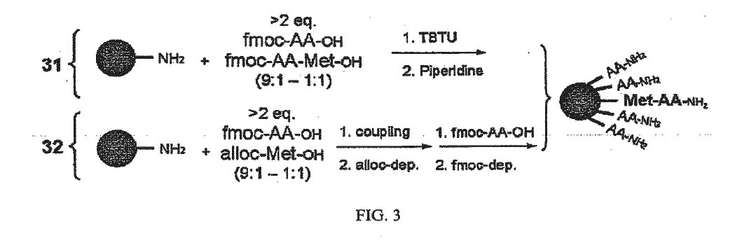

In another embodiment, a mixture of a biopolymer monomer precursor and a cleavable linker precursor may be used to incorporate a cleavable linker into a fraction of biopolymer chains, as shown in FIG. 3. For example, in one embodiment, biopolymer chains may be reacted with a mixture of a biopolymer monomer precursor and a cleavable linker precursor, the cleavable linker precursor comprising the cleavable linker attached to the same monomer as in the biopolymer monomer precursor. This approach results in a mixture of biopolymer chains where all of the chains have the same sequence except that a portion of the biopolymer chains additionally contain the cleavable linker. Alternatively, the biopolymer monomer precursor and the cleavable linker precursor may each contain only a single monomer. In this approach, it may be desirable to use orthogonal protecting groups on the biopolymer monomer precursor and the cleavable linker precursor. In some embodiments, using orthogonal protecting groups can allow selective deprotection of the biopolymer monomer and the cleavable linker. Thus, as shown in FIG. 3, cleavable linker precursor alloc-Met-OH may be selectively deprotected using, for example, a Pd catalyst, while leaving biopolymer monomer precursor fmoc-AA-OH intact. One or more monomers may then be added to the cleavable linker. It should be understood that in instances where the biopolymer monomer precursor and the cleavable linker precursor both belong the same category of biopolymer subunit (e.g., both are amino acid precursors, nucleotide precursors, sugar precursors, etc.) they may be distinguishable. It should also be understood that the ratio of the biopolymer monomer precursor to the cleavable linker precursor may be adjusted to achieve a desired fraction of biopolymer chains containing the cleavable linker. In some embodiments, the ratio of the biopolymer monomer precursor to the cleavable linker precursor may be greater than 1:1, in certain embodiments greater than 5:1, in certain embodiments greater than 9:1, in certain embodiments greater than 20:1, and in certain embodiments greater than 50:1.

In some embodiments, biopolymers may be mixed with a surface and allowed to attach to the surface, i.e., presynthesized biopolymer may be attached to the surface. In some embodiments, a fraction of the biopolymers may comprise a cleavable linker. In one embodiment, particles may be placed in vials and a unique biopolymer, where a fraction of the unique biopolymer comprises a cleavable linker, may be added to each vial and allowed to attach to the surface of the particles. Thus, a library of unique biopolymers attached to particles may be created.

As discussed above, a library of unique biopolymers may be screened. One embodiment of a screening assay may be conducted as follows. A library of unique biopolymers, a fraction of each unique biopolymer containing a cleavable linker, may be provided. Each unique biopolymer may be attached to an individual particle. It should be understood that multiple copies of each particle may be provided. The library of biopolymers may be contacted by a target species (e.g., a protein), and the non-specifically bound target species washed away using, for example, a blocking solution. In some embodiments, the blocking solution may be formulated such that target species remain bound only to biopolymers for which the target species exhibits a binding affinity above a threshold level. The particles of the library may then be sorted to identify those particles with specifically bound target species (i.e., “hits”). For example, an antibody sandwich assay may be used to visualize the target species bound to the biopolymers on the particles. In some embodiments, the particles may be sorted multiple times, where each sorting round eliminates essentially the particles exhibiting the weakest association with a target species. The sorted particles may be deposited into vials, with one particle per vial. The cleavable biopolymer chains on each bead may then be cleaved to produce biopolymer fragments. Cleavage may be accomplished using one of the reagents discussed above or any other suitable reagent. The biopolymer fragments may then be subjected to any suitable analysis. In some embodiments, the biopolymer fragments may be sequenced. In some embodiments, mass spectrometry may be used to sequence a biopolymer. For example, MALDI-TOF mass spectrometry and MS/MS may be used to analyze (e.g., sequence) the biopolymer fragments. In some cases, the biopolymer fragments may be partially digested using, for example, an enzyme in order to create a “ladder” of different biopolymer fragment lengths for sequencing.

In some embodiments, further analysis may be conducted to measure the binding affinity of the hits (i.e., the biopolymers exhibiting binding activity) for the target species. For example, the hit biopolymers may be resynthesized without being attached to particles and subjected to surface plasmon resonance experiments to measure the binding affinity. In another embodiment, a dot blot assay may be used to measure the binding affinity as described in the Examples below.

An “amino acid” is given its ordinary meaning as used in the field of biochemistry. An isolated amino acid typically, but not always (for example, as in the case of proline) has a general structure NH₂—CHR—COOH. R may be any suitable moiety; for example, R may be a hydrogen atom, a methyl group, or an isopropyl group. A series of isolated amino acids may be connected to form a peptide or a protein by reaction of the —NH₂ of one amino acid with the —COOH of another amino acid to form a peptide bond (—CO—NH—). In such cases, each of the R groups on the peptide or protein can be referred to as an amino acid residue. The amino acid may be one of the 20 amino acids commonly found in nature (the “natural amino acids”), or an unnatural amino acid, i.e., an amino acid that is not one of the natural amino acids. Non-limiting examples of unnatural amino acids include alloisoleucine, allothreonine, homophenylalanine, homoserine, homocysteine, 5-hydroxylysine, 4-hydroxyproline, 4-carboxyglutamic acid, cysteic acid, cyclohexylalanine, ethylglycine, norleucine, norvaline, 3-aminobutyric acid, beta-amino acids (e.g., beta-alanine), N-methylated amino acids such as N-methylglycine, N-methylalanine, N-methylvaline, N-methylleucine, N-methylisoleucine, N-methylnorleucin, N-methyl-2-aminobutyric acid, N-methyl-2-aminopentanoic acid, etc., as well as the D-isomers of the natural amino acids.

In one embodiment, a kit may be provided, containing one or more of the above compositions. A “kit,” as used herein, typically defines a package or an assembly including one or more of the compositions of the invention, and/or other compositions associated with the invention, for example, as previously described. Each of the compositions of the kit may be provided in liquid form (e.g., in solution), in solid form (e.g., a dried powder), etc. A kit of the invention may, in some cases, include instructions in any form that are provided in connection with the compositions of the invention in such a manner that one of ordinary skill in the art would recognize that the instructions are to be associated with the compositions of the invention. For instance, the instructions may include instructions for the use, modification, mixing, diluting, preserving, administering, assembly, storage, packaging, and/or preparation of the compositions and/or other compositions associated with the kit. The instructions may be provided in any form recognizable by one of ordinary skill in the art as a suitable vehicle for containing such instructions, for example, written or published, verbal, audible (e.g., telephonic), digital, optical, visual (e.g., videotape, DVD, etc.) or electronic communications (including Internet or web-based communications), provided in any manner.

International Patent Application No. PCT/SG2009/000258, filed Jul. 22, 2009, entitled “Differentiation of Isobaric Amino Acids and Other Species,” by Heath et al., and U.S. Provisional Patent Application No. 61/225,881, filed Jul. 15, 2009, entitled “Method for the Improved Screening of Bead-Based Peptide and Peptide Mimetic Libraries Using Partially Cleavable Peptides,” by Heath et al., are incorporated herein by reference.

The following examples are intended to illustrate certain embodiments of the present invention, but do not exemplify the full scope of the invention.

### Example 1

This example demonstrates various methods of constructing peptide libraries containing methionine cleavable groups. FIG. 2 illustrates two methods that describe embodiments for utilizing methionine as a cleavable group.

The first method (21) represents a modification of the coupling step in the standard peptide coupling for constructing OBOC peptide libraries. As shown in the FIG. 2, the beads (11) that are used for OBOC libraries are typically pre-equipped with molecular functionalities for further chemical modifications. A standard example would be a polyethylene glycol oligomer that is terminated with an amine (—NH₂) chemical group, as shown in FIG. 2. In this way, amide coupling chemistry, which is used to couple amino acids serially to form peptides, can be employed on-bead. When amino acids are coupled onto the bead, they are typically protected from subsequent reactions through the use of fmoc (fluoren-9-ylmethoxycarbonyl) group. The extent of the coupling of fmoc-protected methionine (fmoc-Met-OH) may be controlled by limiting the amount of added reagents so that only a fraction of the exposed NH₂ groups are reacted. After that partial coupling is completed, the OBOC library is constructed according to standard literature protocols.

The second method (22) employs an activated ester form of fmoc-methionine, which undergoes amide formation in the presence of N,N′-diisopropylethylamine (DIPEA). The incorporation of fmoc-protected methionine by using the activated ester form is controlled so that only a fraction of the exposed NH₂ groups are reacted. This is similar to method (21), although the slowly reacting activated ester facilitates more control over the extent of partial methionine coupling to the bead-bound NH2 groups. The resulting beads undergo fmoc deprotection and the subsequent coupling of an fmoc-protected amino acid (fmoc-AA-OH). After another fmoc-deprotection by piperidine, the beads are appended by the same distribution of peptides as are elaborated by the first method (21). Both methods can be utilized to incorporate methionine into a fractional amount of the OBOC peptide library at any position, including a branch point, a mid-point of a linear peptide, or the C-terminus of a linear peptide.

FIG. 3 illustrates two other methods for attaching amino acid sequences on beads by using two pre-mixed amino acid reagents. The third method (31) involves the use of dimeric peptides having methionine appended to a fmoc-protected second amino acid. For example, a fraction of fmoc-Leu-Met-OH (leucine-methionine) is pre-mixed with fmoc-Leu-OH and used for coupling to amino resin if the amino acid at C-terminus is leucine. If the coupling rates of both fmoc-Leu-OH and fmoc-Leu-Met-OH are comparable, the fraction of the sites that end up with a methionine group is simply related to the relative amounts of fmoc-Leu-OH and fmoc-Leu-Met-OH that were mixed initially. Otherwise, the amounts of these two molecules that should be added must be calibrated against the relative reaction rates of these two compounds. Once this first step is complete, then the subsequent amino acid (AA) is coupled onto the H₂N-Leu- and H₂N-Leu-Met- sites on resin using standard reagents (fmoc-AA-OH) and standard peptide coupling chemistry protocol. For this example, the amino acid leucine can obviously be replaced by any naturally occurring or non-naturally occurring amino acid (AA). This method (31) then produces a library in which each bead has a controllable fraction of the peptides coupled onto the bead via methionine.

The fourth method (32) provides significant flexibility for the subsequent incorporation of amino acids. By using different protective groups this method does not require pre-synthesized dimers. N-allyloxycarbonyl (Alice) groups can be easily removed by a standard protocol using Pd catalyst, and the exposed free amine groups are coupled with incoming fmoc-protected amino acid (fruoc-AA-OH) to elaborate the identical species obtained by the previous method (31).

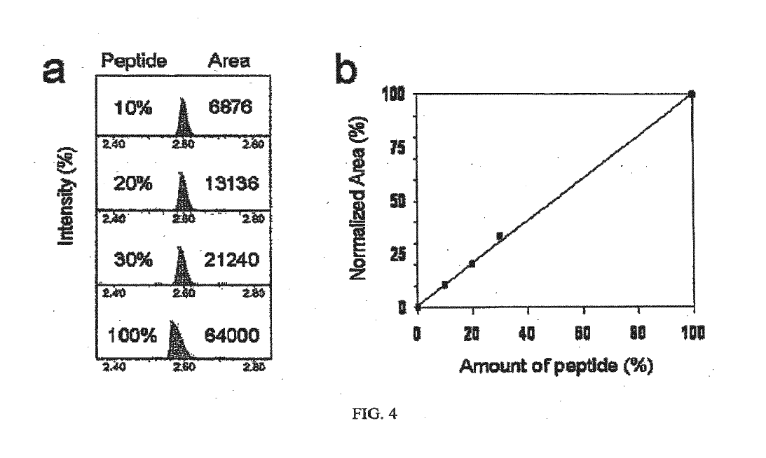

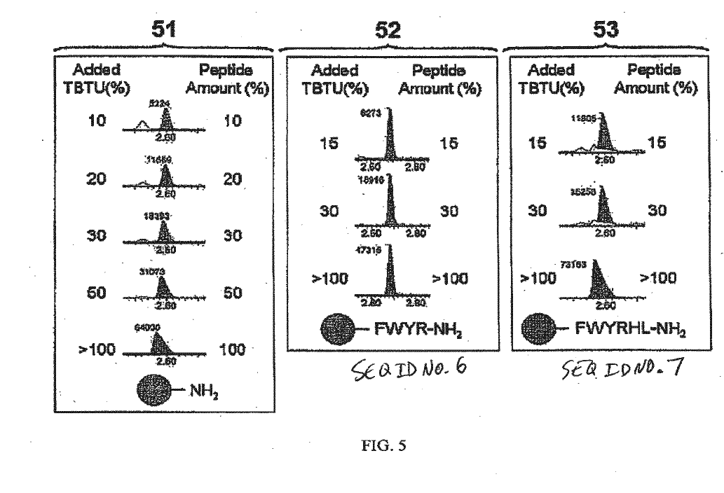

Step 1. Validation of chemistry for OBOC library preparation: The fractional amount of methionine that could be appended onto beads was determined. For this measurement, a standard calibration curve was obtained by running liquid chromatography (LC) at different concentrations of a model peptide, Ac-Phe-Leu-Homoserine lactone (FIG. 4). Utilizing this curve, the fractional amount of methionine can be determined in any type of beads that bear free amino groups, N-termini of linear peptides, and amino group at a mid-point of peptides. This method was investigated as shown in FIG. 5. The first example (51) resulted from fractional methionine coupling to free amine groups on beads. The added amount of fmoc-protected methionine and a coupling agent (TBTU) was varied from 10% to >100% for the initial coupling with amine groups on beads, prior to subsequent construction of a short peptide for analysis by LC. The highest coupling efficiency (>90%) was obtained when TBTU was the limiting agent. The two reagents were premixed in NMP for 10 min in 2:1 ratio prior to addition to the beads in the presence of 2 equiv of DIPEA. To incorporate 10 percent methionine as a linker, for example, the quantity of fmoc-Met-OH and TBTU was limited to 20 percent and 10 percent, respectively. The following construction of a short peptide was performed by a standard peptide synthesis protocol using a double coupling method at each step. The N-terminus was acetylated with acetic anhydride, and the beads then had the peptide sequence: Ac-Phe-Leu-Met, in which the fraction of methionine varies from 10% to 100%. Thus, only a fraction of the bead-bound peptides contained methionine as a cleavable linker at the C-terminus. That fraction of peptides was cleaved using standard CNBr-mediated cleavage protocols, and the amount of cleaved peptide was analyzed as a function of the amount of TBTU that was added for coupling onto the beads at the start. Based upon the results in (51) the necessary amount of TBTU to achieve 10% coupling is 13%, for example.

The second example (52) was obtained from beads appending a tetrameric peptide H₂N-RYWF (SEQ ID NO. 6). In this case, about 15% of TBTU needs to be used for 15% coupling of methionine, for example. The third example (53) also demonstrates reliable method for fractional coupling in the case of beads appending a more flexible hexameric peptide H₂N-LHRYWF (SEQ ID NO. 7). Similarly, about 15% of TBTU is necessary for 15% coupling of methionine in this case.

From the experiments described in FIGS. 4 and 5, the necessary amount of each reagent for designated fraction of methionine coupled to any type of N-terminus on beads can be easily determined.

### Experimental Details

General: N-methylpyrrolidone (NMP), diethylether and dichloromethane (DCM) were purchased from Merck. Fmoc-protected amino acids (Fmoc-AA's), 2-(1H-Benzotriazole-1-yl)-1,1,3,3-tetramethyluronium tetrafluoroborate (TBTU) and N,N-diisopropylethylamine (DIEA) were purchased from GL Biochem (Shanghai) Ltd. Trifluoroacetic acid (TFA) and triisopropylsilane (TIS) were purchased from Aldrich. a-cyano-4-hydroxycinnamic acid (CHCA) was purchased from Bruker. MALDI-MS and MS/MS were obtained with Bruker Autoflex II TOF/TOF.

Partial coupling of methionine to TentaGel S Amino resins (10% coupling as an example): TentaGel S Amino resins (200 mg, capacity=0.29 mmol/g) were swelled in NMP (3 ml) for 2 h in a vial. After centrifugation for 1 min, most solvent was taken up and a solution of fmoc-Met-OH and TBTU (0.26 and 0.13 equiv, respectively), prepared by stirring for 10 min in NMP (1 ml), was added in the presence of DMA (2 equiv, 0.5 M solution in NMP). The resulting mixture was vortexed for 30 min, which were thoroughly washed by NMP (3 ml×4) after draining the reaction solution. Fmoc group was removed by treatment twice with 20% piperidine in NMP (3 ml each, v/v) for 5 min and then 15 min. The solution was drained and the beads were thoroughly washed by NM? (3 ml×4) and DCM (3 ml×4).

Subsequent synthesis of a peptide Ac-F-L-M (10-100%): To the methionine-bound beads (10-100%), after swelling in NMP (3 ml) for 2 h, fmoc-Leu-OH (2 equiv, 0.2 M solution in NMP), TBTU (2 equiv, 0.2 M solution in NMP), and DMA (5 equiv, 0.5 M solution in NMP) were added and the resulting mixture was vortexed for 30 min. The liquid was drained and the coupling was repeated using fresh reagent solutions with vortexing for another 30 min. Fmoc group was removed by treatment twice with 20% piperidine in NMP (3 ml each, v/v) for 5 min and then 15 min. The solution was drained and the beads were thoroughly washed by NMP (3 ml×4) and DCM (3 ml×4). The coupling and deprotection were repeated with fmoc-Phe-OH. Finally, the N-terminus was acetylated by treatment with acetic anhydride (10 equiv) and DIEA (20 equiv) in NMP (3 ml) for 30 min. The resulting beads were thoroughly washed by NMP (3 ml×4), methanol (3 ml×4), DCM (3 ml×4), and then diethylether (3 ml), which were dried under reduced pressure for 24 h.

CNBr-mediated cleavage of a single bead: A precise quantity of beads (ca. 5 mg) with variable fractions of methionine was placed in a 2 ml Eppendorf tube. Deionized water (200 ul) was added and the tube was carefully purged with argon for 1 min. CNBr (200 μl, 0.50 M in 0.2 N HC1 solution) was added to the tube, which was sealed and vortexed at ambient temperature for 15 hr. The resulting solution was concentrated under centrifugal vacuum for 2 h.

Step 2. Accurate sequencing of linear and branched peptides with 10% cleavable linker: For this step, it was demonstrated that, when only a fraction (<<50%) of a known peptide could be cleaved from a single bead, accurate sequencing information could still be obtained. Sequencing was done using standard mass spectrometric methods. For this experiment, bead-bound peptides of both linear and branched varieties were prepared. The peptides were constructed so that, for the linear peptides, 10% of the peptides on a given bead could be cleaved using standard CNBr-mediated cleavage chemistry. For the branched peptides, CNBr was utilized to cleave 10% of the peptides at the branch point. Data are shown in FIG. 4. For this demonstration, 6 linear and 6 branched peptides, each of known composition, were cleaved and sequenced with 100% accuracy. All measurements were done on single beads.

### Experimental Details

Synthesis of pentameric peptides from N-terminus of HLYFLR (SEQ ID NO. 1) on beads (linear peptides): Starting from swelling TentaGel S Amino resins (600 mg, capacity=0.29 mmol/g), the backbone sequence was sequentially constructed by incorporating R, L, F, Y, L, and H according to standard fmoc peptide synthesis protocol via double coupling method as described in Step 1. Incorporation of 10% methionine was performed as described in Step 1, prior to dividing beads into 6 equal batches for the subsequent construction of each pentameric peptides, following the same protocols (double coupling). Protective groups for the residues were removed by treatment with trifluoroacetic acid cleavage cocktail (2 ml, TFA/TIS/water=94/3/3, v/v/v) for 2 h. The resulting beads were dried in vacuo for 24 h after being washed vigorously by NMP (3 ml×4), methanol (3 ml×4), DCM (3 ml×4), and then diethylether (3 ml).

Synthesis of pentameric peptides from a mid-point of HLYFLR (SEQ ID NO. 1) on beads (branched peptides): First, the backbone hexamer peptide Ac-HLG(4-azido-1-butyl)FLR was constructed on TentaGel S Amino beads (600 mg, capacity=0.29 mmol/g) by following the procedure described in Step 1 (double coupling). The protective groups remained intact for the following couplings. The beads were contained in a 25 ml reactor, equipped with a filter, and shaken for swelling in NMP (12 ml) for 2 hr. Fmoc-Pra-OtBu (3 equiv), copper iodide (0.1 equiv), and DMA (3 ml) were added and the reactor was shaken for 15 hr. The reaction solution was removed from the resin, which was washed with a solution of sodium diethyldithiocarbamate trihydrate (Et₂NCSSNa.3H₂O, 1% w/v), containing DIEA (1%, v/v) in NMP (15 ml×5) to remove the coordinated copper species generated by the click reaction. Washing was repeated until both the resin and solution were colorless. After removal of fmoc group by treatment twice with 20% piperidine in NMP (15 ml each, v/v) for 5 min and then 15 min, incorporation of 10% methionine was performed as described in Step 1. The resulting beads were divided into 6 equal batches for the subsequent construction of each pentameric peptides, following the same protocols (double coupling). Protective groups for the residues were removed by treatment with trifluoroacetic acid cleavage cocktail (2 ml, TFA/TIS/water=94/3/3, v/v/v) for 2 h. The resulting beads were dried under vacuum for 24 h after being washed vigorously by NMP (3 ml×4), methanol (3 ml×4), DCM (3 ml×4), and then diethylether (3 ml).

MALDI-MS sampling for peptides from a single bead with 10% methionine linker: The MS and MS/MS experiments were performed using Bruker Autoflex III TOF/TOF. To each vial or well added a-cyano-4-hydroxycinnamic acid (CHCA) (2 ul, 0.5% solution in acetonitrile/water (70:30, v/v)) and then acetonitrile/water (2 ul, 70:30, v/v, containing 0.1% trifluoroacetic acid (v/v)). The sample was centrifuged for 2 min and 2 ul was taken up and spotted onto a Bruker 384-well MALDI-MS plate and air-dried for 15 min.

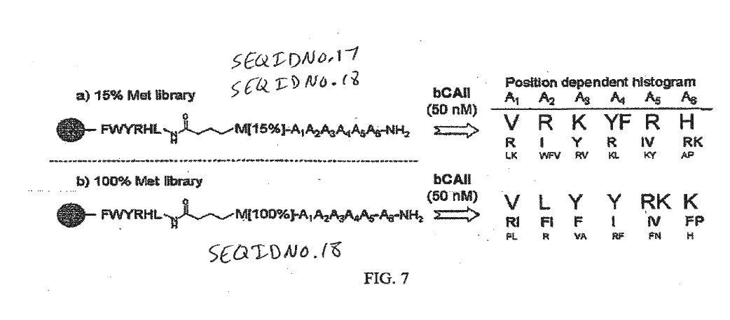

Step 3. Demonstration of the benefits of a partially cleavable OBOC peptide library for protein affinity screening. Next, it was demonstrated that, when an OBOC library was screened to determine peptide binders to a given protein, beads that used the method described in this Example produced statistically different hits from beads that didn't use the method described in this Example. In order to maximize the effects of the fractional linker system, a hexameric peptide was first appended on beads. The sequence LFIRYWF was found as a first-generation anchor peptide from an initial screening of a hexameric peptide library against bCAII, which showed a few micromolar 1 CD of affinity in a Surface Plasmon Resonance (SPR) study. Next, two different hexameric peptide as a variable region in the libraries were constructed with 15% and 100% methionine at C-terminus using 18 unnatural (D) amino acids as monomers, excluding cystein and methionine. Incorporation of 15% methionine was achieved by the method described in Step 1 and a standard synthesis protocol was utilized for 100% methionine (double coupling). The AAPPTEC Titan 357 was employed to facilitate the “split-and-mix” approach. The entire process was performed in a fully automatic fashion by following the standard solid-phase fmoc chemistry. With the initial methionine introduced as a CNBr cleavable linker, the beads were evenly distributed to 18 reaction vessels (RV) prior to the coupling with each of 18 diversity elements. The cycle of split, coupling, Fmoc-deprotection, and mix was repeated 6 times and the protective groups were completely removed by TFA cleavage cocktail. The two libraries were thereby available for a biochemical screening against a protein of interest, bovine carbonic anhydrase II (bCAII). The purity of peptides on beads was checked by MALDI-TOF/TOF, prior to screening process. The libraries were incubated against 50 nM of bovine carbonic anhydrase (bCAII), conjugated with Alexa Fluor® 647 for fluorescence detection, at 25° C. for 20 h. Hit beads were sorted into a 96 well plate in an automatic fashion by COPAS Plus and the appended peptides were released by treatment with CNBr, which were delivered to MALDI-MS station for characterization. The position-dependent histograms in FIG. 7 illustrate clear difference between the two libraries, which implies the significant interference can be attributed to the linker portion, thereby to perturb the screening results.

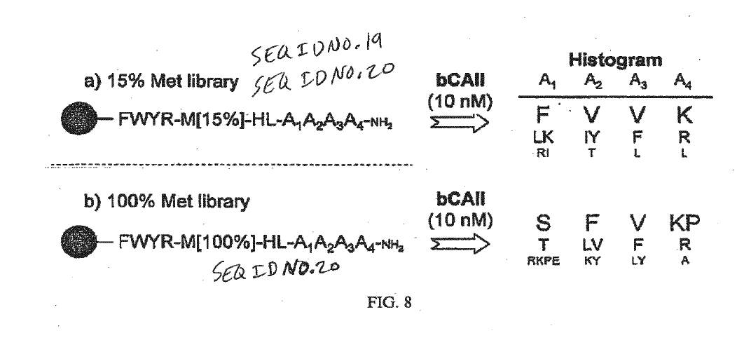

Another comparison was performed with two tetrameric peptide libraries, in which a cleavable linker was placed in the middle of the anchor peptide LHRYWF (SEQ ID NO. 7) (FIG. 8). The libraries were synthesized in a similar way with 15% and 100% methionine incorporated between H and R, respectively. The libraries were incubated against 10 nM of bovine carbonic anhydrase (bCAII), conjugated with Alexa Fluor 647 for fluorescence detection, at 25° C. for 20 h. The sequencing results were depicted as the position-dependent histograms in FIG. 8, which illustrate distinct outcomes between the two libraries. These results support the interference of the linker portion to the screening process.

### Experimental Details

Synthesis of hexameric peptide libraries with 15% and 100% methionine as a cleavable linker appended to an anchor peptide LHRYWF (SEQ ID NO. 7): The synthesis was performed using an automatic synthesizer AAPPTEC Titan 357. Starting from. TentaGel S Amino beads (1.8 g each, loading of NH2: 0.24 mmol/g), standard fmoc chemistry was utilized to construct the anchor sequence LHRYWF (SEQ ID NO. 7), followed by incorporation of 4-aminobutyrate at N-terminus. To the resulting beads 15% methionine was introduced as described in Step 1 while the regular double coupling method was applied for 100% methionine series. Then beads were distribution equally into 18 Reaction Vessels (RV). One of the 18 selected fmoc-protected d-amino acids as diversity elements (3 equiv), excluding cystein and methionine, TBTU (3 equiv) and DIEA (7.5 equiv) were added to each RV. The RV was then vortexed for 30 min. After draining the solution, the coupling step was repeated. The resulting beads in each RV were washed by NMP (2 ml×4). Again, 20% piperidine in NMP (2 ml×4) was added to each RV, which was vortexed for 15 min. The liquid was drained and a fresh solution of 20% piperidine in NMP (2 ml×4) was added with vortexing for another 30 min. Beads in each RV were thoroughly washed by NMP (2 ml×4) and DCM (2 ml×4), which were combined into the CV. The overall split, coupling, deprotection, and mix processes were repeated 6 times until the beads appended additional hexamers. The beads were transferred to a 50 ml reactor, equipped with a filter. The protective groups in the residues were removed by shaking in TFA-water-TIS (27 ml, 94:3:3, v/v) for 2 h. The liquid was drained and the resulting beads were thoroughly washed by DCM (27 ml×3), methanol (27 ml×3), water (27 ml×3), methanol (27 ml×3), DCM (27 ml×3), and diethylether (27 ml), successively, and then dried under reduced pressure for 24 h.

Synthesis of tetrameric peptide libraries, with 15% and 100% methionine as a cleavable linker appended in between H and R of an anchor peptide LHRYWF (SEQ ID NO. 7): The synthesis was performed using an automatic synthesizer AAPPTEC Titan 357. Starting from TentaGel S Amino beads (1.8 g each, loading of NH2: 0.24 mmol/g), standard fmoc chemistry was utilized to construct the anchor sequence RYWF (SEQ ID NO. 6), followed by incorporation of either 15% methionine as described in Step 1 or 100% methionine by the regular double coupling method. H and L were coupled to the resulting beads (double coupling), which were then distributed equally into 18 Reaction Vessels (RV). One of the 18 selected fmoc-protected d-amino acids as diversity elements (3 equiv), excluding cystein and methionine, TBTU (3 equiv) and DIEA (7.5 equiv) were added to each RV. The RV was then vortexed for 30 min. After draining the solution, the coupling step was repeated. The resulting beads in each RV were washed by NMP (2 nil×4), Again, 20% piperidine in NMP (2 ml×4) was added to each RV, which was vortexed for 15 min. The liquid was drained and a fresh solution of 20% piperidine in NMP (2 ml×4) was added with vortexing for another 30 min. Beads in each RV were thoroughly washed by NMP (2 ml×4) and DCM (2 ml×4), which were combined into the CV. The overall split, coupling, deprotection, and mix processes were repeated 4 times until the beads appended additional tetramers. The beads were transferred to a 50 ml reactor, equipped with a filter. The protective groups in the residues were removed by shaking in TFA-water-TIS (27 ml, 94:3:3, v/v) for 2 h. The liquid was drained and the resulting beads were thoroughly washed by DCM (27 ml×3), methanol (27 ml×3), water (27 ml×3), methanol (27 ml×3), DCM (27 ml×3), and diethylether (27 ml), successively, and then dried under reduced pressure for 24 h.

Library screening and bead sorting: Alexa Fluor® 647 protein labeling kit (A20173, Invitrogen) was chosen as reactive dye for labeling bovine carbonic anhydrase (bCAII) followed by the supplier's protocol. In brief of labeling, 0.5 ml of bCATI solution, prepared by dissolving 2 mg in 1 nil of 0.1 M sodium bicarbonate solution (pH—8.3), was transferred into the vial containing the reactive dye. The vial was capped and inverted a few times to fully dissolved dye. The reaction mixture was stirred for 1 h at ambient temperature under dark conditions. The Alexa Fluor® 647 labeled bCAII (bCAII-A647) was purified from the mixture by size exclusion purification resin in the kit. The purified bCAII-A647 was characterized by NanoDrop (Thermo Scientific) and gel documentation (Typhoon) after SDS-PAGE. 200 mg of dried library resin was transferred into an 8 ml Alltech vessel and pre-incubated in blocking solution, 0.05% NaN₃, 0.1% Tween 20 and 0.1% BSA in PBS buffer (pH 7.4) for 1 hr on 360-degree shaker at ambient temperature. The buffer solution was drained and then 5 ml of 10 or 50 nM bCAII-A647 diluted in blocking solution was added to the swelled resin. The resulting mixture was incubated for 20 h at 360-degree rotating thermostat shaker. The liquid was drained and non-specifically bound proteins were eliminated by washing 3 times with blocking solution, 7 times with 0.1% Tween 20 in PBS, sequentially. After stringent washing, 200 mg of the assayed library resin was transferred into sample vessel of COPAS Plus (Union Biometrica) and diluted with 200 ml of 0.1% Tween 20 in PBS buffer.

Hit beads were sorted into 200 ul polypropylene tube strip mounted on a 96 titer well plate by COPAS Plus. Gating and sorting regions were optimized and two-step sorting strategy was applied for rapid and robust sorting. The first sorting was to purify beads in high concentration regime (>1000 beads/ml). During the first stage sorting, 200 trig (ca. 300,000 beads) of assayed library beads in PBS was sorted with deionized water as the sheath solution. The beads in the sample cup were passed through the flow cell and focused hydrodynamically at a rate of >100 objects/sec. The time-of-flight (TOF), red fluorescence and red fluorescence peak height of the beads were detected by red diode laser (λ=635 nm). Due to the auto-fluorescence of the beads, argon ion laser was intentionally turned off to minimize bleed-through effect. In general less than 5,000 beads (<1.7%) were collected in the first sorting. For the second step sorting, the sorted beads from first step were thoroughly washed with deionized water and transferred in sample cup of COPAS Plus and diluted with 100 ml of deionized water. The beads in the sample cup were passed through the flow cell at a rate of <5 objects/sec. Each hit bead was directly sorted into a conical-shaped well of a 96 titer well plate.

### Example 2

This example demonstrates a screening assay using a biopolymer library.

All OBOC peptide libraries utilized here were prepared using the double coupling method to ensure high purity peptide on beads. An anchor sequence for a target biomarker bCAII was obtained by stepwise screenings of i) a hexameric library that was comprehensive in the non-natural D-stereoisomers, i.e. enantiomers of natural L-amino acids, except cysteine and methionine, and ii) a focused hexameric library using amino acids selected based upon the results from screening the former library. In Example 2, D-stereoisomers are referred to by the lower-case of the standard, single letter abbreviation (e.g. W=L-tryptophan, w=D-tryptophan). A typical incubation was performed for 18 hours with 10 nM of bCAII-AlexaFluor 647 conjugate in a buffer solution in the presence of bovine serum albumin (BSA) as a blocking agent to suppress non-specific bindings. Sorting was automatically performed using COPAS Plus (Union Biometrica), prior to MALDI-MS/MS sequencing of the cleaved peptides from single beads using optimized CNBr cleavage conditions.

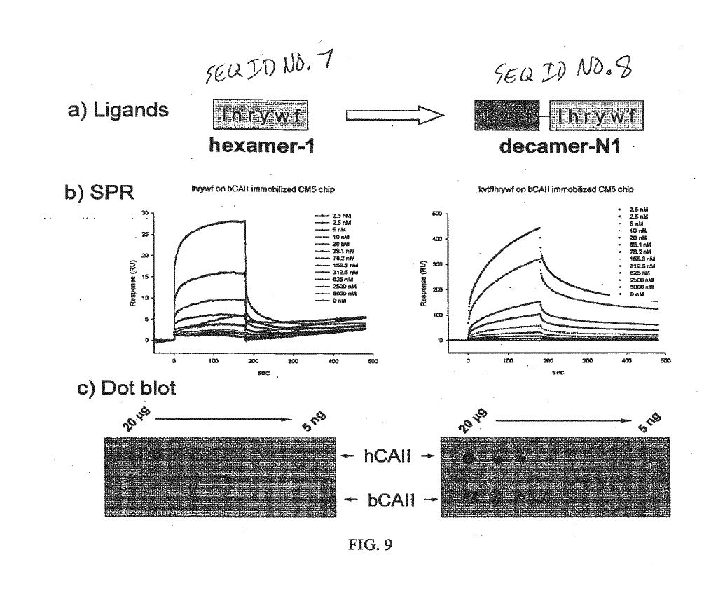

With an anchor peptide hexamer-1 (lhrywf) (SEQ ID NO. 7) in hand, a new variable region was constructed by appending tetramer peptides starting from N-terminus with incorporation of methionine in between h and r so that the cleaved compounds could be hexameric peptides to facilitate MS sequencing. The quantity of coupled methionine was only 15 to 20 percent to prevent adverse influence of the cleavable linker in the binding process, while N-terminus was blocked by acetyl group to reduce non-specific bindings. The decamer-N1 (kvtflhrywf) (SEQ ID NO. 8) was selected directly among the results from the initial screening, i.e. without generation of a focused library. Both hexamer-1 (lhrywf) (SEQ ID NO. 7) and decamer-N1 (kvtflhrywf) (SEQ ID NO. 8) were reconstructed staring from Rink amide resin with N-terminus blocked by acetyl group. For dot blot experiments the peptides were conjugated with biotin at C-terminus via using PEG2 (Merck, 20 atoms) as a tether (FIG. 9). While both peptides turned out interacting with bCAII, the elongated decamer-N1 (kvtflhrywf) (SEQ ID NO. 8) did not only show higher response unit (RU) in Surface Plasmon Resonance (SPR) sensogram but much more antibody-like behavior in association-dissociation pattern. Dot blot experiments also support that the decamer-N1 became more potent towards bCAII by showing more spots in a serial reduction of deposited bCAII along the line. Interestingly, even though the hexamer-1 was more potent towards human carbonic anhydrase II (hCAII), the elongated decamer-N1 turned out similarly potent towards both bovine and human markers. These results indicate that this approach clearly worked to enhance the potency and specificity of the peptide ligands via simple elongation method. It is noteworthy that the incorporation of partial incorporation helped minimize the participation of the cleavable linker in the screening process, so that the elongated decamer-N1 proved to be a true hit obtained by a reliable screening.

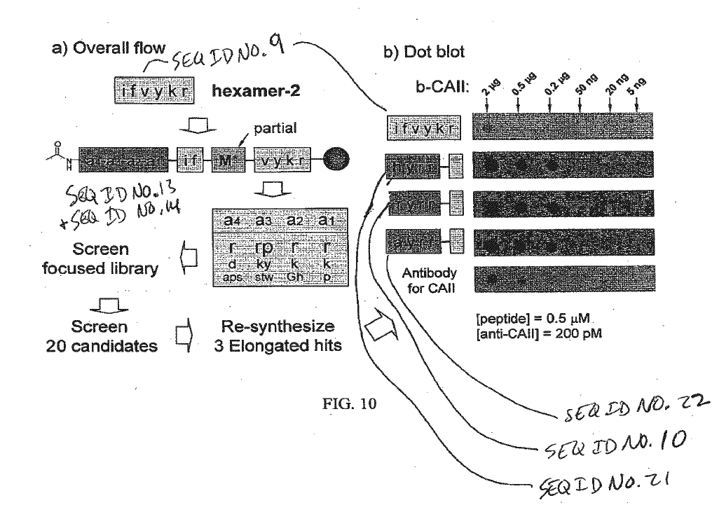

Elongation at N-terminus of the anchor peptide. A new screening campaign was carried out using more optimized assay conditions as well as more accurate sorting and sequencing skills. Another anchor peptide hexamer-2 (ifvykr) (SEQ ID NO. 9) was obtained and examined by SPR and dot blot to show even better property than hexamer-1 towards bCAII. Starting from hexamer-2, another elongated library was constructed in a similar way locating partial portion of methionine between f and v. Based upon the screening results from the comprehensive hexameric library, appearing as a histogram in a box, a focused library was constructed and screened to give 20 candidates for elongated decameric ligands (FIG. 10). A quick screening was performed by placing the 20 candidate peptides under competitive environments towards bCAII. Finally the three decameric peptides were selected and reconstructed and tested in dot blot experiments. While all the three decameric peptides became significantly enhanced in affinity compared to their precursor hexamer-2 by showing the developed spots up to 20 ng of deposited bCAII, the decamer-3 (ryrr-ifvykr) (SEQ ID NO. 10) appeared most prominent for further investigation.

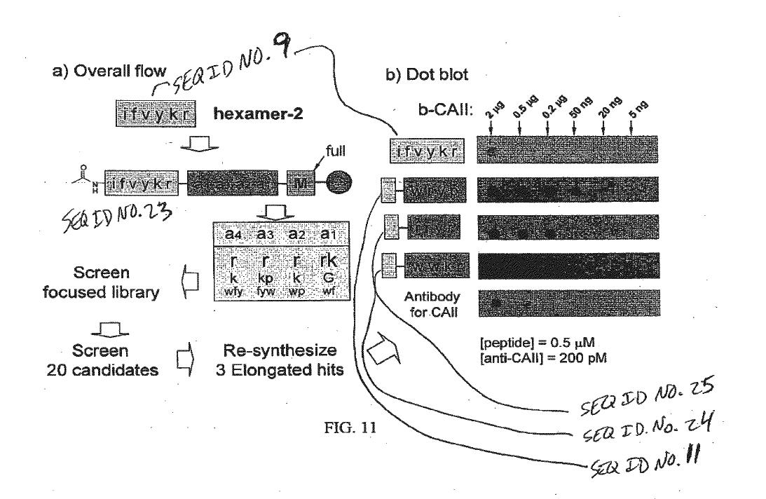

Elongation at C-terminus of the anchor peptide. Elongation at C-terminus started with incorporation of 100% methionine, which made synthesis and MS operations easier. Instead of partial coupling of methionine to the TentaGel S amino resin, excess amount of Fmoc-methionine was used to fully couple the cleavable linker. Then the synthesis continued with constructing variable tetrameric region, employing 18 d-amino acids excluding methionine and cysteine, followed linear synthesis of the anchor motif, ifvykr (SEQ ID NO. 9). The N-terminus was blocked by acetyl group as described above. Despite advantages of easy synthesis and MS sampling due to using 100% cleavable linker, de novo sequencing of the cleaved decameric peptides was more challenging especially for the amino acids near N-terminus, due to the reduced mass sensitivity of the relatively large ionized fragments. It seemed the optimal length of peptides for rapid and robust de novo peptide sequencing seems up to 10 amino acids. The overall flow proceeded in a similar fashion to that of elongation at N-terminus, i.e. two more screenings of a focused library and 20 candidates (FIG. 11). The final three decameric peptides were reconstructed with biotin labeled at C-terminus for validation by dot blot to exhibit significantly increased affinity compared to the precursor hexamer-2 (ifvykr) (SEQ ID NO. 9). It is noteworthy that their affinities appeared comparable to those of elongated hits from N-terminus to display the developed spots clearly up to 20 ng. Among the 3 elongated hits, the decamer-4 (ifvykr-wryp) (SEQ ID NO. 11) appeared most prominent for further investigation.

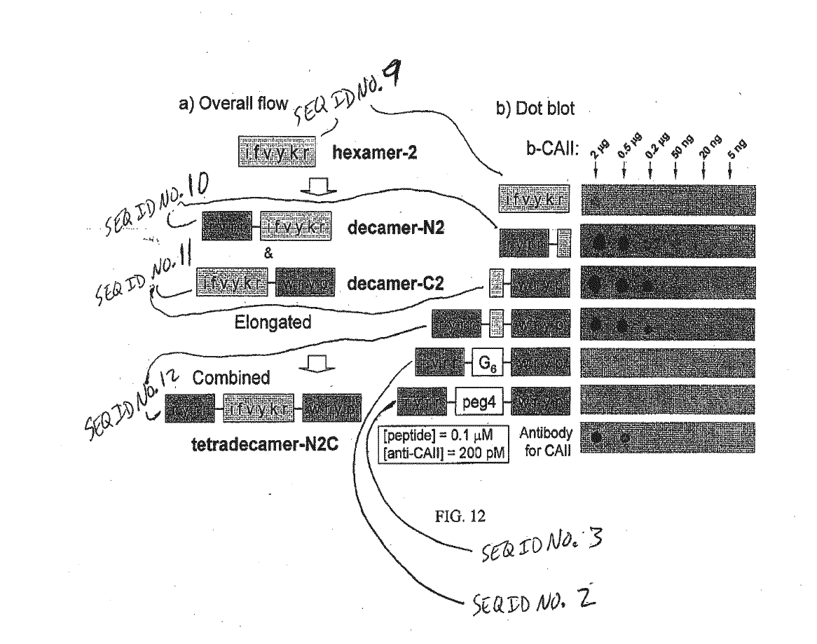

Combination of the elongated peptides. It was obvious that the affinity would become even greater by combining the two elongated peptide ligands with the anchor motif retained in the middle. The combined tetradecamer-N2C (ryrr-ifvykr-wryp) (SEQ ID NO. 12) was elaborated by typical peptide synthesis, starting from appending biotin moiety at C-terminus, followed by placing PEG2 moiety as a spacer (FIG. 12). Two other peptides were also synthesized for comparison by replacing the anchor motif with i) six consecutive glycines, and ii) PEG4 (19 atoms) of a similar length [Chung, S.; Parker, J. B.; Bianchet, M.; Amzel, L. M.; Stivers, J. T. Nat. Chem. Biol. 2009, 5, 407-413]. The concentration of each peptide ligand was reduced from 0.5 μM to 0.1 μM, expecting to observe higher affinity depicted by more number of spots. In short, the affinity of the tetradecamer-N2C was not dramatically improved from the two precursors, decamer-N2 and decamer-C2, although it was again far more potent than the initial anchor hexamer-2 (ifvykr) (SEQ ID NO. 9). The two peptides without the anchor motif turned out not significantly binding to bCAII. These results indicate that the anchor motif can drive the binding affinity towards the target marker, even though the peptides still contain segmented sequences that should interact with the target in some degree. It seems the binding affinity driven by each tetrameric peptide (ryrr and wryp) (SEQ ID NO. 4 and SEQ ID NO. 5, respectively) is not enough to exhibit spots within the given concentration range. Another possibility is that the secondary conformation of the six consecutive glycines is significantly different from that of the anchor motif (ifvykr) (SEQ ID NO. 9) to prevent the tetrameric peptide region from accessing the binding site. It might be interesting to replace the six glycines with a more flexible linker group to support this hypothesis.

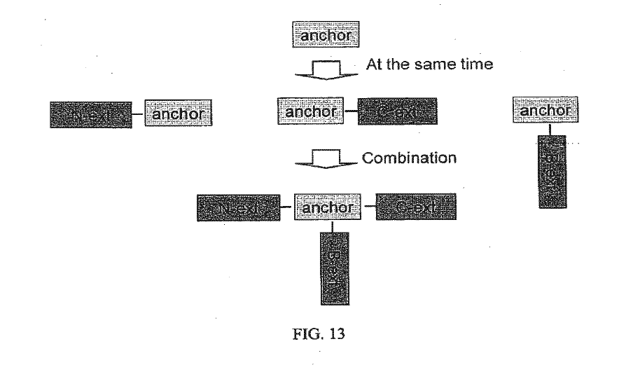

Elongations at each terminus and any branched point can be performed synchronously to reduce the development time. Each elongated segment can be then combined to elaborate a multi-ligand-type capture agent that may be potent and specific enough to replace an antibody (FIG. 13).

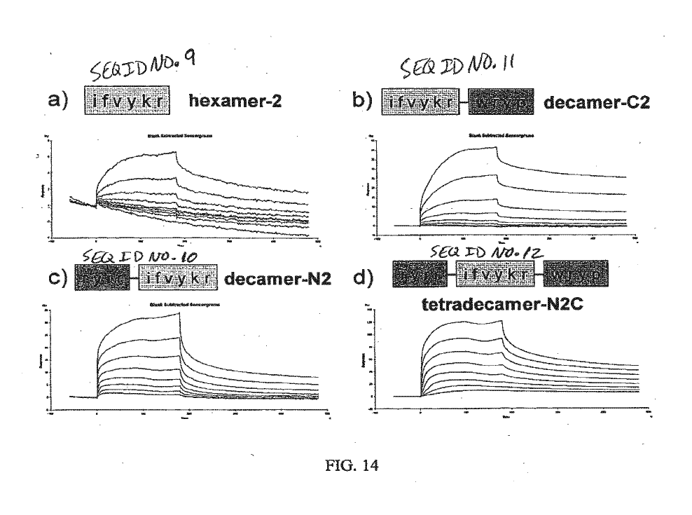

Validation by SPR. The peptide ligands were investigated for their binding affinity towards bCAII using SPR as a validation tool. The target marker was immobilized onto CM5 sensor chip to a response unit (RU) of 1000 in a Biacore T100 system. Each peptide solution of a series of concentrations was eluted through the surface of the chip to observe the response as well as the dissociation pattern mediated by treatment of glycine-hydrochloride. As depicted in FIG. 14, the maximum responses (Rmax) by the peptide ligands increased in a stepwise fashion from the hexamer-2 to the decamers and then to the tetradecamer (8→40→140) at the highest concentration (1.0 μM). It is noteworthy that the combined ligand did not only show high response but also more antibody-like pattern in association and dissociation. These results clearly support that our elongation approach is highly efficient to enhance the affinity towards a given target marker.

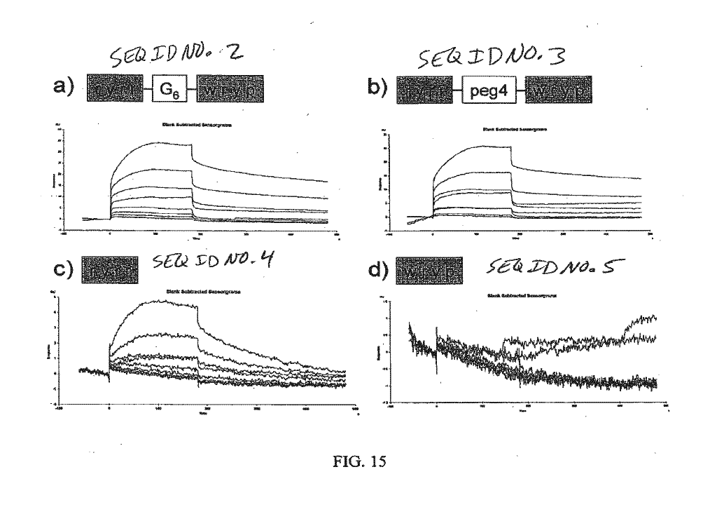

More SPR experiments were performed using four other peptides (FIG. 15). The first two peptides that contain G6 and PEG4, respectively, instead of the motif sequence (ifvykr) (SEQ ID NO. 9), turned out as responsive as the two decamers in FIG. 14 with RU of 30 to 40. In dot blot experiments they did not show significant affinity towards bCAII. The tetramers seemed too weakly binding to give only low responses, although they still exhibited ligand-like behaviors.

### Experimental Section

General. N-methylpyrrolidone (NMP), diethylether and dichloromethane (DCM) were purchased from Merck. Fmoc-protected amino acids (Fmoc-AA's), 2-(1H-Benzotriazole-1-yl)-1,1,3,3-tetramethyluronium tetrafluoroborate (TBTU) and N,N-diisopropylethylamine (DIEA) were purchased from GL Biochem (Shanghai) Ltd. Trifluoroacetic acid (TFA) and triisopropylsilane (TIS) were purchased from Aldrich. A series of Fmoc-protected PEG-COOH and Biotin-NHS were purchased from Merck. α-cyano-4-hydroxycinnamic acid (CHCA) was purchased from Bruker. MALDI-MS and MS/MS were obtained with Bruker UltrafleXtreme™ MALDI-TOF/TOF. The microwave-assisted CNBr cleavage reaction was performed by a household microwave oven (Model: R-248J, 800 W, 2450 MHz) from Sharp Inc.

Synthesis of peptide libraries (both full and partial methionine as a cleavable linker). The synthesis of peptide libraries was performed by using an automatic synthesizer Titan 357 (AAPPTEC). TentaGel S amino beads (1.8 g, 90 μm; capacity=0.30 mmol/g; 2.86×10⁶ beads/g) were swelled in NMP (27 ml) for 2 hr in the Collective Vessel (CV). For incorporation of full methionine as a linker, Fmoc-methionine (2.5 equiv, 0.2 M solution in NMP) was added to the CV, as well as TBTU (2.5 equiv, 0.2 M solution in NMP), and DIEA (5 equiv, 0.5 M solution in NMP), after draining the solvent. The resulting mixture was vortexed for 30 min. The solution was drained and the resulting beads were thoroughly washed by NMP (27 ml×3). For incorporation of partial (20 percent for example) methionine as a linker, Fmoc-methionine (0.4 equiv) was pre-incubated with TBTU (0.2 equiv) in NMP (20 ml) for 10 min, prior to addition of the swelled beads (1.8 g). After 5 min of vortexing, DIEA (2.0 equiv, 0.5 M solution in NMP) was added to the suspension. The resulting mixture was vortexed for 30 min, prior to washing with NMP (27 ml×3). Next, piperidine in NMP (27 ml, 20%, v/v) was added and the CV was vortexed for 5 min. The liquid was drained and the beads were treated by fresh portion of piperidine in NMP (27 ml, 20%, v/v) for 15 min). The resulting beads were thoroughly washed by NMP (27 ml×3) and DCM (27 ml×3), followed by distribution equally into 18 Reaction Vessels (RV). One of the 18 amino acid diversity elements (2 equiv, excluding cysteine and methionine, 0.2 M solution in NMP), as well as TBTU (2 equiv, 0.2 M solution in NMP), and DIEA (5 equiv, 0.5 M solution in NMP), was added to each RV. The RV was then vortexed for 30 min. After draining the solution, the coupling step was repeated. The resulting beads in each RV were washed by NMP (1.5 ml×3). The removal of Fmoc group was performed using two fresh portions of piperidine in NMP (1.5 ml each, 20%, v/v) for 5 min and 15 min, respectively. After the solution was drained the beads in each RV were thoroughly washed and by NMP (1.5 ml×3) and DCM (1.5 ml×3), which were then combined to CV. The overall split, coupling, deprotection, and mix processes were repeated until the beads appended the intended length of peptides. If necessary, acetyl group was introduced at N-terminus by treatment of the beads with acetic anhydride (15 ml, 0.3 M solution in NMP) in the presence of DIEA (15 ml, 0.5 M solution in NMP) for 15 min. The combined beads were contained in a 50 ml reactor, equipped with a filter. The acid-labile protective groups for the residues were removed by shaking in TFA-water-TIS (27 ml, 95:2.5:2.5, v/v/v) for 2 h. The solvent was drained and the resulting beads were thoroughly washed by DCM (27 ml×3), methanol (27 ml×3), water (27 ml×3), methanol (27 ml×3), DCM (27 ml×3), and diethylether (27 ml), successively, and then dried under reduced pressure for 24 h.

Synthesis of peptide ligands. The wells in RV of the automatic synthesizer Titan 357 (AAPPTEC) were used as the reactors. Rink amide resins (100 mg, the loading of amino group: 0.31 mmol/g) were swelled in NMP (1.5 ml) for 15 min and then solvent was drained. After removal of Fmoc group by treatment with piperidine in NMP (1.5 ml×2, 20% v/v) for 5 min and 15 min, respectively, the required Fmoc-amino acids (2.5 equiv, 0.2 M solution in NMP), TBTU (2.5 equiv, 0.2 M solution in NMP), and DIEA (5 equiv, 0.2 M solution in NMP) were added successively and the resulting beads were vortexed for 30 min. The deprotection-coupling cycle was repeated using the required Fmoc-amino acid at each step until the beads appended the aimed sequence. In the case of synthesis of biotin-labeled peptides, Fmoc-Lys(Mtt)-OH was coupled initially, followed by removal of Mtt group by successive treatment with solution of TFA/TIS/DCM (1.5 ml each, 1/5/94 v/v/v) for 2 min, 5 min, 30 min, respectively. The resulting beads were thoroughly washed with DCM (1.5 ml×3) and NMP (1.5 ml) and then DIEA solution in NMP (1.5 ml, 0.1 M). Biotin-NHS (1.5 equiv) and DIEA (5 equiv) were treated to beads in NMP (1.5 ml) with vortexing for 15 min, the resulting beads were thoroughly washed with NMP (1.5 ml×3). The resulting beads were thoroughly washed by NMP (3 ml×4). Next, 20% piperidine in NMP (5 ml, v/v) was added and the RV was vortexed for 5 min. The liquid was drained and a fresh solution of 20% piperidine in NMP (3 ml, v/v) was added and the RV was vortexed for another 15 min. The resulting beads were thoroughly washed by NMP (3 ml×4) and DCM (3 ml×4). The necessary amino acids or PEG group was sequentially introduced as described above using 18 non-natural Fmoc-protected amino acids, excluding cysteine and methionine, and Fmoc-PEG-COOH. If necessary, acetyl group was introduced at N-terminus by treatment of the beads with acetic anhydride (1 ml, 0.3 M solution in NMP) in the presence of DIEA (1 ml, 0.5 M solution in NMP) for 15 min. The beads were transferred to an 8 ml reactor equipped with a filter, and incubated in trifluoroacetic acid (TFA)/water/TIS (2 ml, 94/3/3, /v/v/v) at room temperature for 2 h. The cleavage solution was collected and concentrated in a nitrogen stream. The final purification was carried out by using a preparative HPLC to produce the desired peptide with carboxamide group at C-terminus (typical quantity 1-5 mg, purity>95%) in a white solid.

Screening and sorting of libraries. For screening, the bCAII protein was first labeled using the Alexa Fluor 647 protein labeling kit (A20173, Invitrogen) according to the supplier's protocol. First, a 2 mg/mL solution of bCAII was dissolved in 0.1 M sodium bicarbonate (pH≈8.3). Then 0.5 mL of this bCAII solution was transferred into the vial of the reactive dye. The vial was capped and inverted a few times to fully dissolve the dye. The reaction mixture was stirred for 1 h at room temperature under dark conditions. The Alexa Fluor 647-labeled bCAII was purified from the mixture using the size exclusion purification resin in the labeling kit. Purified and labeled bCAII was characterized by UV-vis spectroscopy and SDS-PAGE. For the screen, 100 mg of library resin was transferred into an 8 mL Alltech vessel and preincubated in a blocking solution, 0.05% NaN3, 0.1% Tween 20, and 0.1% BSA in PBS buffer (pH 7.4), for 1 h on a 360° shaker at 25° C. The buffer solution was drained by vacuum, and then 5 mL of 10 nM dye-labeled bCAII diluted in blocking solution was added to the swollen resin. The resulting mixture was incubated for 15-18 h on a 360° shaker at 25° C. The liquid was drained by vacuum, and nonspecifically bound proteins were eliminated by washing three times with blocking solution and three times with 0.1% Tween 20 in PBS buffer sequentially. Last, the resin was washed six times with PBS buffer. After stringent washing, 200 mg of the assayed library resin was transferred into a sample vessel of COPAS Plus (Union Biometrica) [Fields, G. B.; Noble, R. L. Int. J. Pept. Protein Res. 1990, 35, 161-214] and diluted with 200 mL of PBS buffer (pH 7.4). Two-step sorting was applied. In the second sorting, positive beads were directly sorted into a 96 titer well plate with cone-shaped wells. CNBr cleavage and MALDI-MS and MS/MS follow.

Cleavage of peptides from the sorted single beads by CNBr. A single bead was transferred to a micro-sized vial containing 10 μL deionized water. The reaction vessel was purged by argon for 15 min and then CNBr (10 μL, 0.50 M in 0.2 N HCl solution) was added into the vessel. After additional purging by argon for 15 min, the vial was placed under microwave for 1 min. The resulting solution was concentrated under centrifugal vacuum for 10 min at 45° C. and then for 50 min at 60° C.

Analysis of peptides cleaved from single beads using MALDI-MS and MS/MS. For fully cleavable beads, to each vial or well were added CHCA (7 μL, 0.5% solution in acetonitrile/water (70:30)) and then acetonitrile/water (7 μL, 70:30 containing 0.1% TFA (v/v) and 1 mM ammonium phosphate monobasic). For partially cleavable beads (20 percent for example), to each vial or well were added CHCA (2 μL, 0.5% solution in acetonitrile/water (70:30)) and then acetonitrile/water (2 μL, 70:30 containing 0.1% TFA (v/v) and 1 mM ammonium phosphate monobasic). The plate was centrifugated for 2 min and each solution was taken up (2 μl) to be spotted onto a 384-well MALDI plate, which was allowed to stand for 15 mM to dry naturally. MALDI-MS and MS/MS will then be conducted with UltrafleXtreme™ MALDI-TOF/TOF mass spectrometer from Bruker Daltonics.

Surface Plasmon Resonance (SPR) experiments to measure affinity of the re-synthesized peptide ligands. Affinity measurements were performed using a Biacore T100 system and research grade CM5 sensor chips (GE Heathcare). The instrument was primed with HBS-EP+ (GE Heathcare) buffer. Flow cell 1 (or 3) was used as a reference to subtract nonspecific binding, drift, and the bulk refractive index, while flow cell 2 (or 4) was immobilized with the target biomarker (bCAII) following standard procedures. A 1:1 mixture of 0.4 M EDC and 0.1 M NHS was used to activate flow cell 2 (or 4), and 0.1 mg/mL bCAII solution was injected. Blocking of the remaining activated groups was done with a 1 M solution of ethanolamine (pH 8.5). bCAII was immobilized onto the sensor chip surface by approximately 5000 response units (RU). The instrument was then primed using running buffer (HBS-EP+). Each of the 6mer ligand candidates identified were dissolved in HBS-EP+buffer to produce 5 μM peptide stock solutions for each peptide, which were serially diluted by a factor of 2 to produce a concentration series down to 2 nM. For a given affinity measurement, these series of peptide solutions successively were injected into flow cell 2 (or 4) for 3 mM of contact time, 5 min of dissociation time, and 3.5 mM of stabilization time using a flow rate of 100 μL/min at 25° C. Flow cell 2 (or 4) was regenerated by glycine 2.5 (GE Healthcare) after injection of each peptide solution.

Dot blot assays to measure affinity of the re-synthesized peptide ligands conjugated to biotin. The affinity of the peptide ligands for the target biomarker (bCAII) was demonstrated through the use of dot blot experiments in 5% nonfat dry milk in TBS-T [25 mM Tris, 150 mM NaC1, 2 mM KCl, 0.5% Tween 20 (pH 8.0)]. A solution of bCAII was prepared as 10 mg/mL stocks in PBS buffer (pH 7.4). A serial dilution of the mother solution was applied to a nitrocellulose membrane, typically ranging from 2 μg to 5 ng per spot. The membrane was blocked at room temperature for 2 h in 5% nonfat milk/TBS-T. The membrane was then washed with TBS-T. The solution of peptide ligands conjugated to biotin with PEG2 (20 atoms, Novabiochem®) as a linker was prepared at 0.5 μM in 5% nonfat milk/TBS-T and incubated over the membrane for 2 h at room temperature. After washing three times with TBS-T for 10 min, 1:3000 streptavidin-HRP (Abcam) prepared in 0.5% milk/TBS-T was added to the membrane and incubated for 2 h. After washing three times with TBS-T for 10 min, the membrane was treated with chemiluminescent reagents (Amersham ECL plus Western blotting detection reagents, GE Healthcare) and then immediately developed on film.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A composition, comprising:
a mixture of a first biopolymer and a second biopolymer, wherein the second biopolymer is identical to the first biopolymer except at one or more locations where the second biopolymer contains a cleavable linker positioned between two subunits, wherein the first biopolymer and the second biopolymer each comprise amino acid sequences.

2. (canceled)

3. (canceled)

4. (canceled)

5. The composition of claim 1, wherein the cleavable linker is methionine.

6. The composition of claim 1, wherein the first biopolymer and the second biopolymer are attached to a surface.

7. The composition of claim 6, wherein the surface is the external surface of a particle.

8. The composition of claim 1, wherein the ratio of the first biopolymer to the second biopolymer is greater than 1:1.

9. The composition of claim 1, further comprising a plurality of said mixtures, wherein each mixture is attached to a separate particle.

10. The composition of claim 1, wherein the first biopolymer comprises an anchor amino acid sequence and an N-terminus amino acid sequence extension.

11. The composition of claim 1, wherein the first biopolymer comprises an anchor amino acid sequence and a C-terminus amino acid sequence extension.

12. The composition of claim 1, wherein the second biopolymer is at least one subunit longer than the first biopolymer.

13. The composition of claim 1, wherein the second biopolymer comprises at least one more amino acid than the first biopolymer.

14. The composition of claim 1, wherein the second biopolymer has the same number of amino acids as the first biopolymer.

15. A method, comprising:
growing biopolymers on a surface, wherein during the growing step a cleavable linker precursor is added to a medium containing the biopolymers and incorporated into the biopolymers such that only a portion of the biopolymers grown on the surface contain a cleavable linker derived from the cleavable linker precursor, wherein the biopolymers each comprise amino acid sequences.

16. The method of claim 15, wherein the cleavable linker precursor comprises at least one amino acid.

17. The method of claim 15, wherein less than one equivalent of the cleavable linker precursor with respect to reactive centers on the sequences is added to the medium.

18. The method of claim 15, wherein the medium further comprises an amino acid precursor distinguishable from the cleavable linker.

19. The method of claim 18, wherein the ratio of the amino acid precursor to the cleavable linker precursor is greater than 1:1.

20. The method of claim 18, wherein the ratio of the amino acid precursor to the cleavable linker precursor is greater than 5:1.

21. The method of claim 18, wherein the amino acid precursor comprises a first protecting group and the cleavable linker precursor comprises a second protecting group different from the first.

22. The method of claim 15, further comprising growing biopolymers on a plurality of individual particles, wherein each particle comprises a unique biopolymer.

23. A method, comprising:
mixing a plurality of biopolymer species with at least one surface, wherein at least one of the biopolymer species has been modified to contain a cleavable linker positioned between two subunits; and
attaching the plurality of biopolymers to the at least one surface such that only a portion of the biopolymers attached to the surface contain the cleavable linker, wherein the biopolymers each comprise amino acid sequences.

24. A composition, comprising:
a biopolymer attached to a surface, wherein the biopolymer has been modified to contain a cleavable linker positioned between two subunits, wherein the biopolymer contains a binding region separated from the cleavable linker by a distance sufficient to reduce the binding affinity of the binding region for a target species by less than 20%, and wherein the biopolymer comprises an amino acid sequence.

25. (canceled)

26. (canceled)

27. (canceled)

28. (canceled)

29. The composition of claim 24, 32 or 28, wherein a second plurality of the biopolymers are attached to the surface, wherein the second plurality of the biopolymers are identical to the first plurality of the biopolymers except at one or more locations where the biopolymers of the second plurality of biopolymers contain a cleavable linker.

30. The composition of claim 24, 32 or 28, wherein the surface is the external surface of a particle.

31. (canceled)

32. A composition, comprising:
a biopolymer attached to a surface, wherein the biopolymer has been modified to contain a cleavable linker positioned between two subunits, wherein the biopolymer contains a binding region separated from the cleavable linker by at least two biopolymer subunits, and wherein the biopolymer comprises an amino acid sequence.

33. A composition, comprising:
a biopolymer that has been modified to contain a cleavable linker positioned between two subunits, wherein the biopolymer contains a binding region, wherein the cleavable linker is located within five biopolymer subunits of a terminus of the biopolymer that is attached to a surface, and wherein the biopolymer comprises an amino acid sequence.

34. A method of screening a library of biopolymers, comprising:
providing a plurality of particles, wherein each particle comprises a unique first biopolymer and a unique second biopolymer, the second biopolymer comprising a cleavable linker positioned between two subunits;
contacting the plurality of particles with a target;
isolating members of the plurality of particles that bind above a threshold level with the target;
cleaving cleavable linkers on the isolated members of the plurality of particles to release a fragment of the second biopolymer, and
determining the sequence of the fragment of the second biopolymer, wherein the first biopolymer and second biopolymer each comprise amino acid sequences.

35. A library, comprising:
a plurality of particles, wherein each of the particles has attached thereto a first biopolymer and a second biopolymer, wherein the second biopolymer is identical to the first biopolymer except at one or more locations where the second biopolymer contains a cleavable linker positioned between two subunits, and wherein the first biopolymer and second biopolymer each comprise amino acid sequences.

36. The library of claim 35, wherein the first biopolymer and the second biopolymer each comprise amino acid sequences.

37. The library of claim 35, wherein the first biopolymer and the second biopolymer each comprise nucleic acid sequences.

38. The library of claim 35, wherein the first biopolymer and the second biopolymer each comprise polysaccharides.

39. The library of claim 35, wherein the cleavable linker is methionine.

40. The library of claim 35, wherein the ratio of the first biopolymer to the second biopolymer is greater than 1:1.

41. The library of claim 35, wherein the first biopolymer comprises an anchor amino acid sequence and an N-terminus amino acid sequence extension.

42. The library of claim 35, wherein the first biopolymer comprises an anchor amino acid sequence and a C-terminus amino acid sequence extension.

43. The library of claim 35, wherein the cleavable linker increases the length of the second biopolymer as compared to the first biopolymer.

44. The library of claim 36, wherein the second biopolymer comprises at least one more amino acid than the first biopolymer.

45. The library of claim 36, wherein the second biopolymer has the same number of amino acids as the first biopolymer.

46. The composition of claim 24, 32, or 33, wherein the binding region is an epitope.

47. The composition of claim 24 or 33, wherein the binding region and cleavable linker are separated by at least two biopolymer subunits.

48. The composition of claim 24, 32, or 33, wherein the cleavable linker is located within five amino acids of the C-terminus of the amino acid sequence.

49. The composition of claim 33, wherein a first plurality of the biopolymers are attached to a surface.

50. The composition of claim 24, 32, or 33, further comprising a library of unique biopolymers, wherein each of the biopolymers is attached to a separate particle.


SEQUENCE LISTING (27 sequences)

SEQ ID NO: 1 - protein, 6 aa, artificial sequence
  synthetic peptide
HLYFLR

SEQ ID NO: 2 - protein, 14 aa, artificial sequence
  synthetic peptide
RYRRGGGGGGWRYP

SEQ ID NO: 3 - protein, 8 aa, artificial sequence
  synthetic peptide
RYRRWRYP

SEQ ID NO: 4 - protein, 4 aa, artificial sequence
  synthetic peptide
RYRR

SEQ ID NO: 5 - protein, 4 aa, artificial sequence
  synthetic peptide
WRYP

SEQ ID NO: 6 - protein, 4 aa, artificial sequence
  synthetic peptide
RYWF

SEQ ID NO: 7 - protein, 6 aa, artificial sequence
  synthetic peptide
LHRYWF

SEQ ID NO: 8 - protein, 10 aa, artificial sequence
  synthetic peptide
KVTFLHRYWF

SEQ ID NO: 9 - protein, 6 aa, artificial sequence
  synthetic peptide
IFVYKR

SEQ ID NO: 10 - protein, 10 aa, artificial sequence
  synthetic peptide
RYRRIFVYKR

SEQ ID NO: 11 - protein, 10 aa, artificial sequence
  synthetic peptide
IFVYKRWRYP

SEQ ID NO: 12 - protein, 14 aa, artificial sequence
  synthetic peptide
RYRRIFVYKRWRYP

SEQ ID NO: 13 - protein, 10 aa, artificial sequence
  synthetic peptide
XXXXIFVYKR

SEQ ID NO: 14 - protein, 11 aa, artificial sequence
  synthetic peptide
XXXXIFMVYKR

SEQ ID NO: 15 - protein, 11 aa, artificial sequence
  synthetic peptide
FRYKYHLYFLR

SEQ ID NO: 16 - protein, 11 aa, artificial sequence
  synthetic peptide
HLRFKLRGFLR

SEQ ID NO: 17 - protein, 13 aa, artificial sequence
  synthetic peptide
XXXXXXXLHRYWF

SEQ ID NO: 18 - protein, 14 aa, artificial sequence
  synthetic peptide
XXXXXXMXLHRYWF

SEQ ID NO: 19 - protein, 10 aa, artificial sequence
  synthetic peptide
XXXXLHRYWF

SEQ ID NO: 20 - protein, 11 aa, artificial sequence
  synthetic peptide
XXXXLHMRYWF

SEQ ID NO: 21 - protein, 10 aa, artificial sequence
  synthetic peptide
HYRRIFVYKR

SEQ ID NO: 22 - protein, 10 aa, artificial sequence
  synthetic peptide
AYRRIFVYKR

SEQ ID NO: 23 - protein, 11 aa, artificial sequence
  synthetic peptide
IFVYKRXXXXM

SEQ ID NO: 24 - protein, 10 aa, artificial sequence
  synthetic peptide
IFVYKRRRYR

SEQ ID NO: 25 - protein, 10 aa, artificial sequence
  synthetic peptide
IFVYKRWWKR

SEQ ID NO: 26 - protein, 12 aa, artificial sequence
  synthetic peptide
FRYKYMHLYFLR

SEQ ID NO: 27 - protein, 12 aa, artificial sequence
  synthetic peptide
HLRFKLRMGFLR